(19) United States
(12) Patent Application Publication
(10) Pub. No.: US 2007/0207354 A1
(43) Pub. Date: Sep. 6, 2007

(54) Fuel Cartridge with an Environmentally Sensitive Valve

(75) Inventors: Andrew J. Curello, Hamden, CT (US); Anthony Sgroi JR., Wallingford, CT (US); Paul Adams, Monroe, CT (US); Floyd Fairbanks, Naugatuck, CT (US)

Correspondence Address: THE H.T. THAN LAW GROUP, WATERFRONT CENTER SUITE 560, 1010 WISCONSIN AVENUE NW, WASHINGTON, DC, 20007, US

(73) Assignee: SOCIETE BIC, Clichy (FR)

(21) Appl. No.: 11/576,388

(22) PCT Filed: Oct. 3, 2005
(86) PCT No.: PCT/US05/35720

§ 371 Date: Mar. 30, 2007

Related U.S. Application Data
(63) Continuation-in-part of application No. 10/958,574, filed on Oct. 5, 2004.

(51) Int. Cl. H01M 8/04; F16K 31/12; H01M 4/86

(52) U.S. Cl. 429/25

(57) ABSTRACT

The present invention is directed to a fuel supply with an environmentally sensitive valve. The environmentally sensitive valve is sensitive to the environmental factor(s) such as temperature, pressure or velocity. The valve may be configured so that the valve automatically resets when the environmental triggering event no longer exists.

### CROSS-REFERENCE TO RELATED APPLICATION

This application is a continuation-in-part of co-pending application Ser. No. 10/958,574 filed Oct. 5, 2004, which is incorporated by reference herein in its entirety.

### FIELD OF THE INVENTION

This invention generally relates to fuel supplies, such as cartridges, for supplying fuel to various fuel cells. More particularly, the present invention relates to cartridges with an environmentally sensitive valve for controlling fuel flow.

### BACKGROUND OF THE INVENTION

Fuel cells are devices that directly convert chemical energy of reactants, i.e., fuel and oxidant, into direct current (DC) electricity. For an increasing number of applications, fuel cells are more efficient than conventional power generation, such as combustion of fossil fuel and more efficient than portable power storage, such as lithium-ion batteries.

In general, fuel cell technologies include a variety of different fuel cells, such as alkali fuel cells, polymer electrolyte fuel cells, phosphoric acid fuel cells, molten carbonate fuel cells, solid oxide fuel cells and enzyme fuel cells. Today's more important fuel cells can be divided into three general categories, namely (i) fuel cells utilizing compressed hydrogen (H₂) as fuel; (ii) proton exchange membrane (PEM) fuel cells that use methanol (CH₃OH), sodium borohydride (NaBH₄), hydrocarbons (such as butane) or other fuels reformed into hydrogen fuel; and (iii) PEM fuel cells that can consume non-hydrogen fuel directly or direct oxidation fuel cells. The most common direct oxidation fuel cells are direct methanol fuel cells or DMFC. Other direct oxidation fuel cells include direct ethanol fuel cells and direct tetramethyl orthocarbonate fuel cells.

Compressed hydrogen is generally kept under high pressure and is therefore difficult to handle. Furthermore, large storage tanks are typically required and cannot be made sufficiently small for consumer electronic devices. Conventional reformat fuel cells require reformers and other vaporization and auxiliary systems to convert fuels to hydrogen to react with oxidant in the fuel cell. Recent advances make reformer or reformat fuel cells promising for consumer electronic devices. DMFC, where methanol is reacted directly with oxidant in the fuel cell, is the simplest and potentially smallest fuel cell, and also has promising power application for consumer electronic devices.

DMFC for relatively larger applications typically comprises a fan or compressor to supply an oxidant, typically air or oxygen, to the cathode electrode, a pump to supply a water/methanol mixture to the anode electrode, and a membrane electrode assembly (MEA). The MEA typically includes a cathode, a PEM and an anode. During operation, the water/methanol liquid fuel mixture is supplied directly to the anode and the oxidant is supplied to the cathode. The chemical-electrical reaction at each electrode and the overall reaction for a direct methanol fuel cell are described as follows:

Half-reaction at the anode:
CH₃OH+H₂O→CO₂+6H⁺+6e⁻

Half-reaction at the cathode:
O₂+4H⁺+4e⁻→2H₂O

The overall fuel cell reaction:
CH₃OH+1.5O₂→CO₂+2H₂O

Due to the migration of the hydrogen ions (H⁺) through the PEM from the anode through the cathode and due to the inability of the free electrons (e⁻) to pass through the PEM, the electrons must flow through an external circuit, which produces an electrical current through the external circuit. The external circuit may be any useful consumer electronic devices, such as mobile or cell phones, calculators, personal digital assistants, laptop computers and power tools, among others. DMFC is discussed in U.S. Pat. Nos. 5,992,008 and 5,945,231, which are incorporated by reference in their entireties. Generally, the PEM is made from a polymer, such as Nafion® available from DuPont, which is a perfluorinated sulfuric acid polymer having a thickness in the range of about 0.05 mm to about 0.50 mm, or other suitable membranes. The anode is typically made from a Teflonized carbon paper support with a thin layer of catalyst, such as platinum-ruthenium, deposited thereon. The cathode is typically a gas diffusion electrode in which platinum particles are bonded to one side of the membrane.

As discussed above, for other fuel cells fuel is reformed into hydrogen and the hydrogen reacts with oxidants in the fuel cell to produce electricity. Such reformat fuel includes many types of fuel, including methanol and sodium borohydride. The cell reaction for a sodium borohydride reformer fuel cell is as follows:
NaBH₄+2H₂O→(heat or catalyst)→4(H₂)+(NaBO₂)
H₂→2H⁺+2e⁻ (at the anode)
2(2H⁺+2e⁻)+O₂→2H₂O (at the cathode)
Suitable catalysts include platinum and ruthenium, among other metals. The hydrogen fuel produced from reforming sodium borohydride is reacted in the fuel cell with an oxidant, such as O₂, to create electricity (or a flow of electrons) and water byproduct. Sodium borate (NaBO₂) byproduct is also produced by the reforming process. Sodium borohydride fuel cell is discussed in U.S. Pat. No. 4,261,956, which is incorporated by reference herein.

Valves are needed for transporting fuel between fuel cartridges, fuel cells and/or fuel refilling devices. The known art discloses various valves and flow control devices such as those described in U.S. Pat. Nos. 6,506,513 and 5,723,229 and in United States patent application publication nos. US 2003/0082427 A1 and US 2002/0197522 A1. A need exists for a flow valve that responds to changing environmental factor(s) to control the flow of fuel.

### SUMMARY OF THE INVENTION

The present invention is directed to a fuel supply for fuel cells that has a valve actuatable by changing environmental factors such as temperature of the fuel, pressure, or velocity of the fuel flow. The environmental valve operates to protect the fuel cells from fuel surges. In some embodiments, the environmental valve of the present invention may shut off the flow of fuel when a predetermined value of a selected environmental factor is reached. In other embodiments, the environmental valve may allow fuel sufficient to operate the fuel cell to flow through the valve to allow continuing operation of the fuel cell and the electronic equipment it powers.

### BRIEF DESCRIPTION OF THE DRAWINGS

In the accompanying drawings, which form a part of the specification and are to be read in conjunction therewith and in which like reference numerals are used to indicate like parts in the various views:

FIG. 1 is a schematic, perspective view of a consumer electronic device for use with a fuel supply of the present invention, wherein the fuel supply is removed from the device and shown in cross-section;

FIG. 2 is a schematic, perspective view of the fuel supply shown in FIG. 1;

FIG. 3a is a partial, cross-sectional view of a first embodiment of an environmentally sensitive valve for use in the fuel supply in an open state; and FIG. 3b is a partial, cross-sectional view of the first embodiment of the valve of FIG. 3a in a closed state;

FIG. 4a is a partial, cross-sectional view of a positioning mechanism usable with the embodiments of the present invention; FIGS. 4b-4d are partial, cross-sectional views of alternative mechanisms;

FIG. 5 is a partial, perspective view of a second embodiment of the environmentally sensitive valve for use in the fuel supply in an open state;

FIG. 6 is a partial, perspective view of the second embodiment of the valve of FIG. 5 in a closed state;

FIG. 7 is a perspective view of a bimetallic spring for use in a third embodiment of the environmentally sensitive valve for use in the fuel supply;

FIG. 8 is a partial, cross-sectional view of the third embodiment of the environmentally sensitive valve in an open state;

FIG. 9 is a partial, cross-sectional view of the third embodiment of the valve of FIG. 8 in a closed state;

FIG. 10 is a perspective view of another bimetallic spring for use in a fourth embodiment of the environmentally sensitive valve for use in the fuel supply;

FIG. 11 is a partial, cross-sectional view of the fourth embodiment of the valve in an open state;

FIG. 12 is a partial, cross-sectional view of the fourth embodiment of the of FIG. 11 in a closed state; FIGS. 12a-12b are partial, cross-sectional views of alternative embodiments of the valve shown in FIG. 11;

FIG. 13 is a partial, cross-sectional view of a fifth embodiment of the environmentally sensitive valves in an open state;

FIG. 14 is a partial, cross-sectional view of the fifth embodiment of the valves of FIG. 13 in a closed state;

FIG. 15 is a partial, cross-sectional view of a sixth embodiment of the environmentally sensitive valve in an open state;

FIG. 16 is a partial, cross-sectional view of the sixth embodiment of the valve of FIG. 15 in a closed state;

FIG. 17 is a partial, cross-sectional view of a seventh embodiment of the environmentally sensitive valve in an open state;

FIG. 18 is a partial, cross-sectional view of the seventh embodiment of the valve of FIG. 17 in a closed state;

FIGS. 19-21 are cross-sectional views of various alternative embodiments of bimetallic springs for use in various valves of the present invention;

FIG. 22 is a partial, cross-sectional view of an eighth embodiment of the present invention in the unactuated position;

FIG. 23 is a partial, cross-sectional view of the valve of FIG. 22 in an actuated position;

FIG. 24 is a partial, cross-sectional view of the valve of FIG. 22 in another actuated position or alternatively is a partial, cross-sectional view of a ninth embodiment of the present invention in an unactuated position;

FIG. 25 is a partial, cross-sectional view of an alternative positioning of the ninth embodiment of FIG. 24.

FIG. 26 is a partial, cross-sectional view of a tenth embodiment of the environmentally sensitive valve in an open state;

FIG. 27 is a partial, cross-sectional view of the tenth embodiment of the valve of FIG. 26 in a closed state;

FIG. 28a is a partial, cross-sectional view of an eleventh embodiment of the environmental sensitive valve in an open state; FIG. 28b is a partial, cross-sectional view of the eleventh embodiment of the environmentally sensitive valve of FIG. 28a in a closed state;

FIG. 29a is a partial, cross-sectional view of an alternate embodiment of the eleventh embodiment of the valve of FIG. 28 in an open state;

FIG. 29b is a partial, cross-sectional view of the eleventh embodiment of the valve of FIG. 29a in a closed state;

FIG. 30 is a partial, cross-sectional view of a twelfth embodiment of the environmentally sensitive valve in an open state;

FIG. 31 is a partial, cross-sectional view of the twelfth embodiment of the valve of FIG. 30 in a closed state;

FIG. 32 is a perspective view of a sealing member of a thirteenth embodiment of the environmentally sensitive valve;

FIG. 33 is a partial, cross-sectional view of the thirteenth embodiment in an open state;

FIG. 34 is a partial, cross-sectional view of the thirteenth embodiment of the valve of FIG. 33 in a closed state;

FIG. 35 is a partial, cross-sectional view of the thirteenth embodiment of the valve of FIG. 33 in another closed state;

FIG. 36 is a partial, cross-sectional view of a fourteenth embodiment of the environmentally sensitive valve in an open state;

FIG. 37 is a partial, cross-sectional view of the fourteenth embodiment of the valve of FIG. 36 in a closed state; FIG. 37a is a partial, cross-sectional view of an alternative embodiment of the valve shown in FIG. 36;

FIG. 38 is a perspective view of a fifteenth embodiment of the environmentally sensitive valve;

FIG. 39 is a partial, cross-sectional view of the fifteenth embodiment of the valve of FIG. 38 in an open state;

FIG. 40 is a partial, cross-sectional view of the fifteenth embodiment of the valve of FIG. 39 in a closed state;

FIG. 41 is a partial, cross-sectional view of a sixteenth embodiment of the environmentally sensitive valve, wherein the valve is in an open state;

FIG. 42 is a partial, cross-sectional view of the sixteenth embodiment of the valve of FIG. 41 in a closed state;

FIG. 43 is a partial, cross-sectional view of the sixteenth embodiment of the valve of FIG. 41 in another closed state;

FIG. 44 is a cross-sectional view of a seventeenth embodiment of the environmentally sensitive valve in an open state;

FIG. 45 is a partial, cross-sectional view of the seventeenth embodiment of the valve of FIG. 44 in a closed state; FIG. 45a is a cross-sectional view of an alternative embodiment of a temperature sensitive component for use in the valve shown in FIG. 44;

FIG. 46 is a perspective view of a body for use in the valve of FIG. 44;

FIG. 47 is a cross-sectional view of the body of FIG. 46 along arrows 47-47;

FIG. 48 is a perspective view of a cap for use in the valve of FIG. 44;

FIGS. 49-50 are various perspective views of a plunger for use in the valve of FIG. 44;

FIG. 51 is a cross-sectional view of an eighteenth embodiment of the environmentally sensitive valve in an open state;

FIG. 52 is a cross-sectional view of the eighteenth embodiment of the valve of FIG. 51 in a closed state;

FIG. 53 is a cross-sectional view of another embodiment of the valve of FIG. 51;

FIG. 54 is a cross-sectional view of a nineteenth embodiment of a valve with pressure sensitive components according to another aspect the present invention, wherein valve is in an open state;

FIG. 55 is a cross-sectional view of the valve of FIG. 54, wherein the valve is in a closed state;

FIG. 56 is a cross-sectional view of a twentieth embodiment of a valve with a pressure sensitive component according to another aspect the present invention, wherein valve is in a first position;

FIGS. 57-59 are cross-sectional views of the valve of FIG. 55, wherein the valve is in second, third, and fourth positions, respectively;

FIG. 60 is a perspective view of a twenty-first embodiment of a valve containing a pressure sensitive component in the unactuated state;

FIG. 61 is a cross-sectional view of the valve of FIG. 60 along line 61-61;

FIG. 62 in a perspective view of the valve of FIG. 60 is the actuated state;

FIG. 63 is a perspective view of a twenty-second embodiment of a valve containing a pressure sensitive component in the unactuated state;

FIG. 64 is a cross-sectional view of the valve of FIG. 63 along line 64-64;

FIG. 65 is a perspective view of the valve of FIG. 63 in the actuated state;

FIGS. 66A-66D are cross-sectional views of a twenty-third embodiment of a valve component according to another aspect of the present invention;

FIG. 67 is a cross-section of a seal component shown in FIGS. 66A-66D;

FIGS. 68A-68D are cross-sectional views of a twenty-fourth embodiment of a valve component according to another aspect of the present invention;

FIG. 69 is a cross-section of a seal component shown in FIGS. 68A-68D; and

FIG. 70 is a cross-section of an alternate embodiment of a seal component.

### DETAILED DESCRIPTION OF THE INVENTION

As illustrated in the accompanying drawings and discussed in detail below, the present invention is directed to a fuel supply, which stores fuel cell fuels such as methanol and water, methanol/water mixture, methanol/water mixtures of varying concentrations or pure methanol. Methanol is usable in many types of fuel cells, e.g., DMFC, enzyme fuel cell and reformat fuel cell, among others. The fuel supply may contain other types of fuel cell fuels, such as ethanol or alcohols, metal hydrides, such as sodium borohydrides, other chemicals that can be reformatted into hydrogen, or other chemicals that may improve the performance or efficiency of fuel cells. Fuels also include potassium hydroxide (KOH) electrolyte, which is usable with metal fuel cells or alkali fuel cells, and can be stored in fuel supplies. For metal fuel cells, fuel is in the form of fluid borne zinc particles immersed in a KOH electrolytic reaction solution, and the anodes within the cell cavities are particulate anodes formed of the zinc particles. KOH electrolytic solution is disclosed in United States patent application publication no. US 2003/0077493 A1, entitled “Method of Using Fuel Cell System Configured to Provide Power to One or More Loads,” published on Apr. 24, 2003, which is incorporated by reference herein in its entirety. Fuels also include a mixture of methanol, hydrogen peroxide and sulfuric acid, which flows past a catalyst formed on silicon chips to create a fuel cell reaction. Fuels also include a metal hydride such as sodium borohydride (NaBH₄) and water, discussed above, and the low pressure, low temperature produced by such reaction. Fuels further include hydrocarbon fuels, which include, but are not limited to, butane, kerosene, alcohol and natural gas, disclosed in United States patent application publication no. US 2003/0096150 A1, entitled “Liquid Hereto-Interface Fuel Cell Device,” published on May 22, 2003, which is incorporated herein by reference in its entirety. Fuels also include liquid oxidants that react with fuels. The present invention is, therefore, not limited to any type of fuels, electrolytic solutions, oxidant solutions or liquids or solids contained in the supply or otherwise used by the fuel cell system. The term “fuel” as used herein includes all fuels that can be reacted in fuel cells or in the fuel supply and includes, but is not limited to, all of the above suitable fuels, electrolytic solutions, oxidant solutions, gaseous, liquids, solids and/or chemicals and mixtures thereof.

As used herein, the term “fuel supply” includes, but is not limited to, disposable cartridges, refillable/reusable cartridges, containers, cartridges that reside inside the electronic device, removable cartridges, cartridges that are outside of the electronic device, fuel tanks, fuel refilling tanks, other containers that store fuel and the tubings connected to the fuel tanks and containers. While a cartridge is described below in conjunction with the exemplary embodiments of the present invention, it is noted that these embodiments are also applicable to other fuel supplies and the present invention is not limited to any particular type of fuel supplies.

Various environmental factors can negatively affect the performance of fuel cells. For example, high temperature, high fuel flow rate or pressure of the fuel may damage fuel cells. Methanol, which is a preferred fuel, has a low boiling point of about 65° C. This means that if a methanol fuel supply is stored in a warm environment (i.e., with a temperature equal to or greater than 65° C.), such as inside a car in a hot climate or inside a briefcase in a hot climate, the liquid methanol can change to the vapor phase and pressurize the fuel supply. If the fuel supply is connected to an electronic device and changes state, this may cause the fuel to flow at an elevated velocity and damage the fuel cell. Thus, a flow valve for reducing or preventing flow at preselected environmental conditions, such as flow rate or temperature, is desirable.

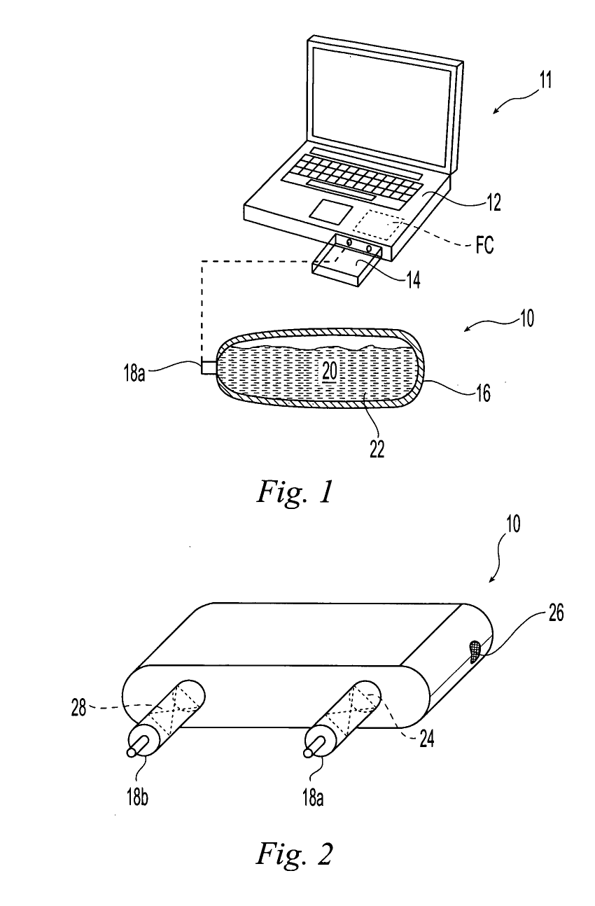

As illustrated in the accompanying drawings and discussed in detail below, the present invention is directed to fuel supply or cartridge 10 for supplying fuel cell FC (shown in phantom) or fuel cell system for powering load 1, as shown in FIG. 1. Load or electrical device 11 is the external circuitry and associated functions of any useful consumer electronic devices that the fuel cell powers. In FIG. 1, fuel cell FC is contained within electrical device 11. Electrical device 11 may be, for example, computers, mobile or cell phones, calculators, power tools, gardening tools, personal digital assistants, digital cameras, computer game systems, portable music systems (MP3 or CD players), global positioning systems, and camping equipment, among others.

In the illustrated embodiment, electrical device 11 is a laptop computer. The free electrons (e) generated by a MEA (not shown) within the fuel cell FC flow through electrical device 11. In the present embodiment, housing 12 supports, encloses and protects electrical device 11 and its electronic circuitry and the remaining components of fuel cell FC (i.e., pump and MEA) as known by those of ordinary skill in the art. Housing 12 is preferably configured such that fuel cartridge 10 is easily inserted and removed from chamber 14 in housing 12 by the consumer/end user.

Cartridge 10 can be formed with or without an inner liner or bladder. Cartridges without liners and related components are disclosed in co-pending United States patent application publication no. US 2004-0151962 A1, entitled “Fuel Cartridge for Fuel Cells,” that published on Aug. 5, 2004 and is incorporated by reference herein in its entirety. Cartridges with inner liners or bladders are disclosed in commonly owned, co-pending United States patent application publication no. US 2005-0023236 A1, entitled “Fuel Cartridge with Flexible Liner,” that published on Feb. 3, 2005 and is also incorporated by reference herein in its entirety.

With further reference to FIGS. 1 and 2, fuel cartridge 10 comprises outer shell or outer casing 16 and first and second nozzles 18a and 18b. Outer casing 16 is configured to define fuel chamber 20 therein for retaining fuel 22. First nozzle 18a houses connecting valve 24 (shown in phantom), which is in fluid communication with fuel chamber 20. Connecting valve 24 can be used to fill chamber 20 with fuel 22. Suitable connecting valves 24 are fully disclosed in commonly owned, co-pending United States patent application publication no. US 2005-0022883, entitled “Fuel Cartridge with Connecting Valve,” that published on Feb. 3, 2005 and is incorporated by reference herein in its entirety.

Cartridge 10 further includes venting valve or optional gas permeable, liquid impermeable membrane 26 that allows air to vent when cartridge 10 is filled. Alternatively, membrane 26 allows gas byproduct produced by the fuel cell reaction and stored in the cartridge to vent during use. Membrane 26 can be a gas permeable, liquid impermeable membrane to allow air to enter as fuel is consumed to minimize vacuum from forming inside cartridge 10. Such membranes can be made from polytetrafluoroethylene (PTFE), nylon, polyamides, polyvinylidene, polypropylene, polyethylene or other polymeric membrane materials. Commercially available hydrophobic PTFE microporous membrane can be obtained from W.L. Gore Associates, Inc., and Milspore, Inc., among others. Gore-Tex® is a suitable membrane. Goretex® is a microporous membrane containing pores that are too small for liquid to pass through, but are large enough to let gas through.

Second nozzle 18b houses shut-off or control valve 28 (shown in phantom). Preferably, fuel chamber 20 is also in fluid communication with valve 28. Valve 28 can be used to allow fuel 22 to exit fuel chamber 20. Valve 28 preferably includes an environmentally sensitive component to be discussed in detail below. Alternatively, valve 24 can be omitted and valve 28 can also be used to fill chamber 20 with fuel.

In an open or unactuated state when a selected environmental factor is below a predetermined threshold level, the environmentally sensitive material or component is in an initial or open position that allows the normal flow of fuel 22 from chamber 20 to fuel cell FC through valve 28. Valve 28 can be used along with a pump to selectively transport fuel 22 from chamber 20 to fuel cell FC. When the selected environmental factor reaches or surpasses the predetermined threshold, the environmentally sensitive component is actuated and valve 28 changes from the open/unactuated state to a closed/actuated state, which prevents the flow of fuel 22 from chamber 20 to fuel cell FC, or continues to allow the normal flow of fuel 22 to fuel cell FC and may divert the excess fuel elsewhere. In the closed/actuated state, environmentally sensitive valve 28 prevents an excess of fuel flow to the fuel cell. Environmental factors can be selected as temperature, pressure or velocity of fuel flow, among others.

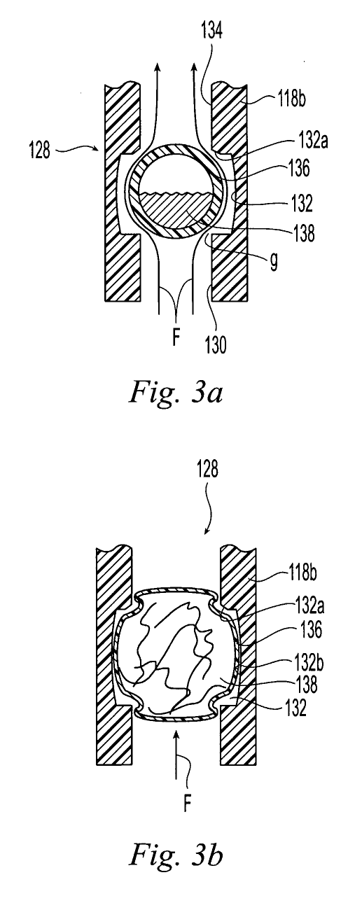

Referring to FIG. 3a, a first embodiment of environmentally sensitive valve 128 is shown comprising nozzle 118b and sealing member 136. Nozzle 118b includes first, second, and third bore sections 130, 132 and 134, respectively. First and third sections 130 and 134 have a diameter smaller than the diameter of second section 132. The diameter of second section 132 is large enough so that sealing member 136, when in an open state, is free to move within second section 132. When fuel is flowing as illustrated by arrows F, at least one gap g is defined within nozzle 118b to allow fuel to flow from fuel chamber 20 to fuel cell FC.

Sealing member 136 can be a bellow, envelope or casing that contains a temperature sensitive material or component 138. The present invention is not limited to the shape of sealing member 136 and sealing member 136 can be spherical, oval, cylindrical or polyhedron, among others. Sealing member 136 is preferably formed of an elastomeric material capable of expanding under pressure and returning to or towards its original shape, and forming a seal when in contact with inner surface of nozzle 118b.

When the fuel is methanol or a blend including methanol, temperature sensitive material 138 preferably has a predetermined threshold temperature equal to or below the boiling temperature of methanol. In one embodiment, temperature sensitive material 138 can be a liquid with a boiling point less that the predetermined threshold temperature. More preferably, the liquid has boiling point of about 3° C. less than the boiling point of fuel, and substantially higher than normal room temperature. While methanol is described herein, the present invention is not limited to any type of fuel.

Suitable liquids for temperature sensitive material 138 with boiling points below about 65° C. or the boiling point of methanol include the compounds listed below:

| Boiling Point ° C. | Compound |
|---|---|
| 63° C. | Azetidine; C₃H₇N |
| | Butane, dicholro-octafluoro-; C₄Cl₂F₈ |
| | 1-Butene, 1-chloro-, (Z)-; C₄H₇Cl |
| | 1,3-Cyclohexadiene, octafluror-; C₆F₈ |
| | Ethanedioyl dichloride; C₂Cl₂O₂ |
| | 1-Hexene; C₆H₁₂ |
| | Hydrazine, 1,1-dimethyl; C₂H₈N₂ |
| | t-Butyl nitrite; C₄H₉NO₂ |
| | Oxirane, ethyl; C₄H₈O₂ |
| | Pentane, 3-methyl; C₆H₁₄ |
| | Propane, 1-ethoxy-; C₅H₁₂O |
| | 1-Propyne, 3-methoxy; C₄H₆O |
| 62° C. | 2-Butanamine; C₄H₁₁N |
| | 2-Butene, 2-chloro, (E)-; C₄H₇Cl |
| | Cyclohexane, undecafluoro-; C₆HF₁₁ |
| | Pentane, 1-fluoro; C₅H₁₁F |
| | Pentene, 2-methyl; C₆H₁₂ |
| 61° C. | Acetic acid, trifluoro-, ethyl; C₄H₅F₃O₂ |
| | Cyanogen bromide; CBrN |
| | Chloroform; CHCl₃ |
| | 1-Pentyne, 4-methyl; C₆H₁₀ |
| | Silane, diethyldifluoro-; C₄H₁₀F₂Si |
| 60° C. | Butane, 2-methoxy- (±); C₅H₁₂O |
| | Cyclobutane, 1,3-dimethyl, cis; C₆H₁₂ |
| | Ethane, isocyanato; C₃H₅NO |
| | Ethene, 1,2-dichloro-, (Z)-; C₂H₂Cl₂ |
| | Oxirane, 2,3-dimethyl, cis-; C₄H₈O |
| | Pentane, 2-methyl-; C₆H₁₄ |
| | 2-Propynal; C₃H₂O |
| | Silane, chlorotrimethyl-; C₃H₉ClSi |
| 59° C. | 1,3-Butadiene, 2-chloro; C₄H₅Cl |
| | Perfluoro-2,3-dimethylbutane; C₆F₁₄ |
| | Cyclopropane, 1-Et-2-Me-; C₆H₁₂ |
| | Cyclopropane, 1,2,3-trimethyl; C₆H₁₂ |
| | Ethane, 1-chloro-2-fluoro-; C₂H₄ClF |
| | 1,5-Hexadiene; C₆H₁₀ |
| | Methane, chloromethoxy-; C₂H₅ClO |
| | Oxetane, 2-methyl-; C₄H₈O |
| | 1-Pentene-3-yne; C₅H₆ |
| | Propane, 1-bromo; C₃H₇Br |
| | Propanoic acid, pentafluoro, methyl ester |
| 58° C. | 1-Butene, 2-Chloro; C₄H₇Cl |
| | Cyclobutane, 1,2-dimethyl-, trans; C₆H₁₂ |
| | Cyclopropane, 1-ethyl-2-methyl-, cis |
| | Cyclopropane, 1-methylethyl; C₆H₁₂ |
| | Ethane, 1,1,2,2-F₄-1,2-dinitro; C₂F₄N₂O₄ |
| | Perfluoro-3-methylpentane; C₆H₁₄ |
| | Pentene, 4-methyl-E |
| | Propane, 1-methoxy-2-methyl; C₅H₁₂O |
| | 1-Propyne, 3-chloro; C₃H₃Cl |
| 57° C. | Butane, 2,3-dimethyl; C₆H₁₄ |
| | Cyclobutane, 1,3-dimethyl, trans; C₆H₁₂ |
| | 1,4-Cyclohexadiene, octafluoro-; C₆H₈ |
| | Ethane, 1,1-dichloro; C₂H₄Cl₂ |
| | 1-Hexene, dodecafluoro; C₆F₁₂ |
| | Methane, selenobis-; C₂H₆Se |
| | Perfluoro-(2-methylpentane); C₆F₁₄ |
| | 1-Pentyne, 3-methyl; C₆H₁₀ |
| | 1-Propene, 1-bromo-, (Z); C₃H₅Br |
| | Silane, diethyl; C₄H₁₂Si |
| 56° C. | Methyl acetate; C₃H₆O₂ |
| | Aziridine; C₂H₅N |
| | 2,4-Dinitroaniline; C₆H₅N₃O₄ |
| | 1-Buten-3-yne, 4-chloro; C₄H₃Cl |
| | Cyclopropane, 1-ethyl-1-methyl; C₆H₁₂ |
| | Ethene, 1-iodo; C₂H₃I |
| | Perfluorohexane; C₆H₁₄ |
| | Oxirane, 2,3-dimethyl-trans; C₄H₈O |
| | 1,4-Pentadiene, 2-methyl; C₆H₁₀ |
| | 2-Pentene, 4-methyl, Z-; C₆H₁₂ |
| | 2-Pentyne; C₅H₈ |
| | Acetone; C₃H₆O |
| 55° C. | 1-Butene, 2,3-dimethyl; C₆H₁₂ |
| | Diethylamine; C₄H₁₁N |
| | 1,3-Pentadiyne; C₅H₄ |
| | Propane, 1-chloro-2,2-difluoro; C₃H₅ClF₂ |
| | Propane, 2-(ethenyloxy)-; C₅H₁₀ |
| | Tert-butyl methyl ether; C₅H₁₂O |
| | Silane, ethenyltrimethyl-; C₅H₁₂Si |
| 54° C. | Cyclopropane, 1,1,2-trimethyl-; C₆H₁₂ |
| | Ethane, 1,1,1-trifluoro-2-iodo-; C₂H₂F₃I |
| | Vinyl formate; C₃H₄O₂ |
| | 2,3-dihydrofuran; C₄H₆O |
| | 2,5-Furandione, 3,3,4,4-F₄—H₂—; C₄F₄O₃ |
| | Acetylacetone, hexafluoro-; C₅H₂F₆O₂ |
| | 1-Pentene, 3-methyl-; C₆H₁₂ |
| | Ethyl isopropyl ether; C₅H₁₂O |
| 53° C. | Diborane, methylthio-; CH₈B₂S |
| | Fluoroiodomethane; CH₂FI |
| | 1-Pentene, 4-methyl-; C₆H₁₂ |
| | Allylamine; C₃H₇N |
| | Propene, 1,2-Cl₂-3,3,3-F₃—; C₃HCl₂F₃ |
| 52° C. | Arsine, trimethyl-; CH₅As |
| | Perfluorocyclohexane; C₆F₁₂ |
| | Perfluorocyclohexene; C₆F₁₀ |
| | Ethane, 1-Br-2-Cl-1,1,2-F₃—; C₂HBrClF₃ |
| | Oxirane, 1,1-dimethyl-; C₄H₈O |
| | 3-Penten-1-yne, Z-; C₅H₆ |
| | 2-Propanethiol; C₃H₈S |
| | 2-Propenal; C₃H₄O |
| 50° C. | Acetyl chloride; C₂H₃ClO |
| | Cyclopropylamine; C₃H₇N |
| | Ethane, 2-Br-2-Cl-1,1,-F₃—; C₂HBrClF₃ |
| | Ethanedial; C₂H₂O₂ |
| | Ethyne, ethoxy-; C₄H₆O |
| | Isopropylmethylamine; C₄H₁₁N |
| | tert-Butyl chloride; C₄H₉Cl |
| 49° C. | Butane, 2,2-dimethyl-; C₆H₁₄ |
| | Cyclopentane; C₅H₁₀ |
| 48° C. | Ethene, 1,2-dichloro-, E-; C₂H₂Cl₂ |
| | Propyl nitrite; C₃H₇NO₂ |
| | 2,3-Pentadiene; C₅H₈ |
| | Propanal; C₃H₆O |
| | 1-Propene, 2-bromo-; C₃H₅Br |
| 47° C. | Ethane, 1,2-Br₂-1,1,2,2,-F₄—; C₂Br₂F₄ |
| | Ethane, 1,1,2-Cl₃-1,2,2-F₃—; C₂Cl₃F₃ |
| | Oxetane; C₃H₆O |
| | Propylamine; C₃H₉N |
| | Propene, 1,2-Cl₂-1,3,3,3-F₄; C₃Cl₂F₄ |
| 46° C. | Carbon disulfide; CS₂ |
| | Ethane, 1,2-Cl₂-1,1-F₂—; C₂H₂Cl₂F₂ |
| | Ethane, 1,2-Cl₂-1,2-F₂—; C₂H₂Cl₂F₂ |
| | Ethane, 1,1,1-Cl₃-2,2,2-F₃—; C₂Cl₃F₃ |
| | Propane, 1-chloro-; C₃H₄Cl |
| | Zinc, dimethyl; C₂H₆Zn |
| 45° C. | Propane, 3-Cl-1,1,1-F₃—; C₃H₄ClF₃ |
| | Allyl chloride; C₃H₅Cl |
| 44° C. | Cyclopentene; C₅H₈ |
| | Cyclopropyl methyl ether; C₄H₈O |
| | 1,2-Pentadiene; C₅H₈ |
| | 1,3-Pentadiene, Z-; C₅H₈ |
| | 3-Pentene-1-yne, Z-; C₅H₆ |
| | tert-Butylamine; C₄H₁₁N |
| | Propionyl fluoride; C₃H₅FO |
| | 1-Propene, 3-methoxy-; C₄H₈O |
| 42° C. | Exo-Methylenecyclobutane; C₅H₈ |
| | Methane, dimethoxy-; C₃H₈O |
| | Methyl iodide; CH₃I |
| | 1,3-Pentadiene, E-; C₅H₈ |
| | 1-Pentene-4-yne; C₅H₆ |
| | 1-Propene, 3-Br-3,3-F2-; C₃H₃BrF₂ |
| | 2-Propynenitrile; C₃HN |
| 41° C. | 1-Butene, 3,3-dimethyl-; C₆H₁₂ |
| | 1,3-Cyclopentadiene; C₅H₆ |
| | Propane, 1,3-difluoro-; C₃H₆F₂ |
| | Silane, dichloromethyl-; CH₄Cl₂Si |
| 40° C. | 1,2-Butadiene, 3-methyl; C₅H₈ |
| | Dichloromethane; CH₂Cl₂ |
| | Isopropyl nitrite; C₃H₇NO₂ |
| | 1-Pentyne; C₅H₈ |

Alternatively, temperature sensitive material 138 can also be a liquid which is a blend of two or more components so than the blend has a boiling point less that the predetermined threshold temperature.

Suitable blends with boiling points below about 65° C. or the boiling point of methanol include the component blends listed below:

| t_{AZ}, ° C. | Component 1 | X₁ | Component 2 |
|---|---|---|---|
| 56.1 | Water | 0.160 | Chloroform |
| 42.6 | | 0.307 | Carbon disulfide |
| 55.7 | Carbon Tetrachloride | 0.445 | Methanol |
| 56.1 | | 0.047 | Acetone |
| 42.6 | Formic Acid | 0.253 | Carbon disulfide |
| 41.2 | Nitromethane | 0.845 | Carbon disulfide |
| 55.5 | Methanol | 0.198 | Acetone |
| 53.5 | | 0.352 | Methyl acetate |
| 38.8 | | 0.263 | Cyclopentane |
| 30.9 | | 0.145 | Pentane |
| 51.3 | | 0.315 | Tert-Butyl methyl ether |
| 57.5 | | 0.610 | Benzene |
| 53.9 | | 0.601 | Cyclohexane |
| 63.5 | | 0.883 | Toluene |
| 59.1 | | 0.769 | Heptane |
| 62.8 | | 0.881 | Octane |
| 42.6 | Carbon disulfide | 0.860 | Ethanol |
| 39.3 | | 0.608 | Acetone |
| 45.7 | | 0.931 | 1-Propanol |
| 46.1 | | 0.974 | Ethyl acetate |
| 44.7 | Ethanol | 0.110 | Cyclopentane |
| 34.3 | | 0.076 | Pentane |
| 58.7 | | 0.332 | Hexane |
| 31.8 | Dimethyl sulfide | 0.503 | Pentane |
| 63.5 | Propanenitrile | 0.134 | Hexane |
| 55.8 | Acetone | 0.544 | Methyl acetate |
| 41.0 | | 0.404 | Cyclopentane |
| 53.0 | | 0.751 | Cyclohexane |
| 32.5 | Ethyl formate | 0.294 | Pentane |
| 55.5 | Methyl acetate | 0.801 | Cyclohexane |
| 51.8 | | 0.642 | Hexane |
| 35.5 | 2-Propanol | 0.071 | Pentane |
| 60.0 | Butanal | 0.296 | Hexane |
| 33.7 | Diethyl ether | 0.553 | Pentane |
| 35.6 | Methyl propyl ether | 0.215 | Pentane |

(See CRC Handbook of Chemistry & Physics, 81^{st} Edition, 2000-2001, pages 6-174 through 6-177)
t_{AZ} = Azeotropic Temperature
X₁ = Mole Fraction of Component 1 for each choice of Component 2

Referring again to FIG. 3a, with valve 128 in its open or unactuated state, fuel flow F is unobstructed. In one embodiment, valve 128 is sensitive to pressure or fuel velocity. When the fuel flow is slow or is below a threshold level, the fuel exerts a pressure on sealing member 136 below a predetermined threshold pressure. The fuel moves through valve 128 and sealing member 136 is not in contact with sealing surface 132a. As a result, fuel flow is not reduced or prevented by valve 128. Sealing surface 132a can be beveled. It can also have a radius or can form a 90° angle between section 132 and 134.

Once fuel flow increases and exerts a pressure on valve 128 which is at or above a predetermined threshold pressure, sealing member 136 is moved into at least partial sealing contact with sealing surface 132a and fuel flow is reduced or prevented. This protects fuel cell FC from velocity or pressure surges in fuel flow rate that can damage or decrease the efficiency 20 of the fuel cell. Once the pressure decreases below the threshold pressure, valve 128 may return to the open or unactuated state.

Valve 128 is also sensitive to temperature. When temperature sensitive component 138 is exposed to a temperature equal to or greater than the predetermined threshold temperature, e.g., about 65° C. when methanol is the fuel, at least some of liquid 138 boils or goes into the gaseous state. The volume within sealing member 136 increases causing sealing member 136 to expand and contact sealing surface 132b of nozzle 118b. Preferably, the contact between sealing member 128 and nozzle 118b is at a smooth surface. The internal pressure from liquid/gas 138 allows a sealing contact to occur between sealing member 136 and sealing surface 132b. Consequently, valve 128 is in an actuated or closed state (as shown in FIG. 3b) and fuel flow F from fuel chamber 20 (see FIG. 1) to fuel cell FC is reduced or prevented. Since valve 128 moves to the closed state before the boiling point of fuel 22, valve 128 prevents fuel flow surges, which could damage fuel cell FC.

When the temperature decreases below the predetermined threshold temperature, material 138 returns to its liquid state and the internal pressure within sealing member 136 reduces, allowing sealing member 136 to return to or towards its original shape and volume.

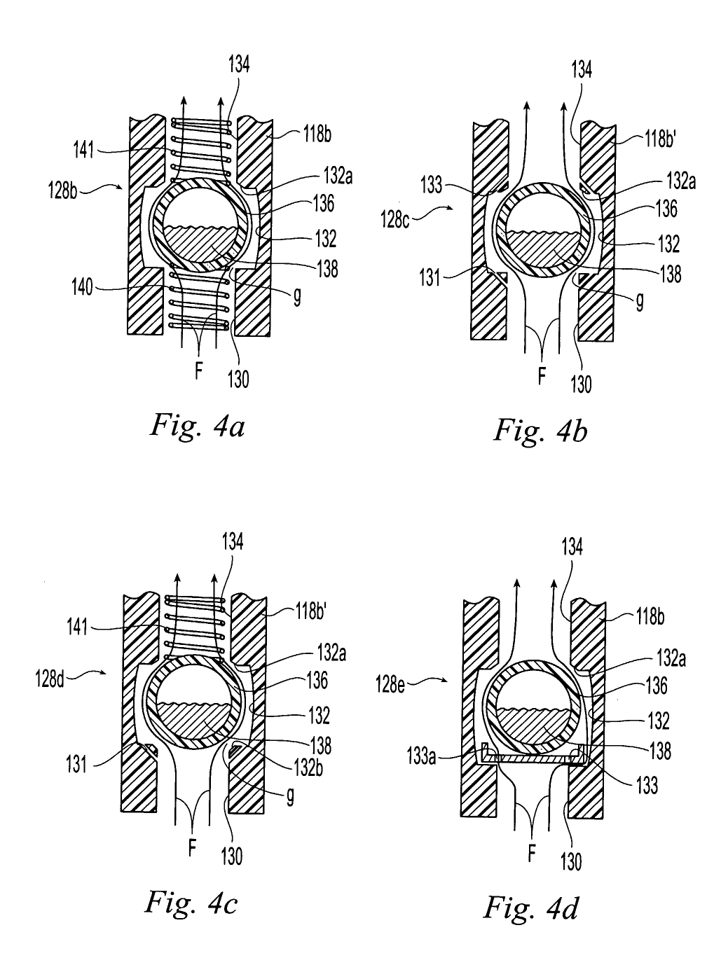

In another embodiment, the positioning device, which can be opposing spring pair 140, 141 shown in FIG. 4a, is utilized to position or counter sealing member 136. Springs 140,141 are supported by stops (not shown) in sections 130 and 134, respectively, and are in contact with sealing member 136 to keep sealing member 136 centered in enlarged section 132. Springs 140,141 can also move sealing member 136 back to open position after actuation. To render valve 128b sensitive only to temperature, the stiffness of spring 141 can be increased to resist movement of sealing member 136 due to flow rate or pressure. The positioning devices above can be employed with other similar embodiments described hereinafter.

In yet another embodiment, valve 128c (shown in FIG. 4b) can include an alternative means for reducing or removing pressure sensitivity from valve 128c. In valve 128c, nozzle 118b′ includes channels 131 from section 130 to section 132 and channels 133 from section 134 to section 132. At any flow speed or pressure, fuel may flow through channels 131 and 133. As a result, fuel flow is not reduced or prevented by valve 128c due to pressure. Valve 128c is sensitive to temperature similar to valve 128. The modification above can be employed with other similar embodiments described hereinafter.

In yet another embodiment, valve 128d (shown in FIG. 4c) can include an alternative means for reducing or removing pressure sensitivity from valve 128d. In valve 128d, nozzle 118b′ includes beveled sealing surface 132b and spring 141 in section 134. Section 130 may also include channel 131 to ensure that fuel flows through valve 128d until the predetermined temperature is reached and sealing member 136 cooperates with the wall of enlarged section 132 to seal the valve. When the fuel flow is slow or is below a threshold level, fuel F exerts a pressure on sealing member 136 below a predetermined threshold pressure, the fuel moves through section 132 and/or through channel 131, and spring 141 has a stiffness to prevent sealing member 136 from moving into sealing contact with sealing surface 132a. As a result, fuel flow is not reduced or prevented by valve 128d. Valve 128d is sensitive to temperature similar to valve 128. This modification can be employed with other similar embodiments described hereinafter.

In yet another embodiment, valve 128e (shown in FIG. 4d) can include an alternative 110 means for altering the pressure sensitivity of valve 128e. In valve 128e, nozzle 118b′ includes beveled sealing surface 132a and flow plate 133 in section 132. Plate 133 may include a number of circumferentially spaced holes 133a therethrough. When the fuel flow is slow or is below a threshold level, fuel F exerts a pressure on sealing member 136 below a predetermined threshold pressure and the fuel moves through section 132 and holes 133a or around plate 133. In this condition, fuel flow is not sufficient to move sealing member 136 into even partial sealing contact with sealing surface 132a. As a result, fuel flow is not reduced or prevented by valve 128e. Plate 133 presents a relatively large and blunt surface to the flow of fuel and increases the pressure sensitivity of the valve. The pressure sensitivity can be reduced depending on the number and size of holes 133a.

Once the fuel flow increases and exerts a pressure at or above predetermined threshold pressure, movement of sealing member 136 aided by plate 133 into at least a partial sealing contact with the sealing surface 132a. As a result, valve 128e is more pressure sensitive than valve 128. Once the pressure decreases below the threshold pressure, valve 128e can return to the open or unactuated state. The modification above can be employed with other similar embodiments described hereinafter. Plate 133 may have upstanding side walls around its circumference to minimize rotation of the plate relative to sealing member 136.

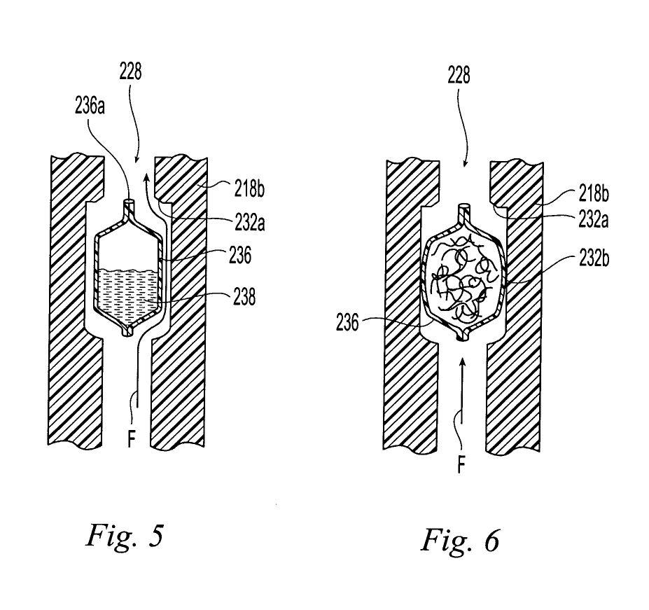

Referring to FIG. 5, a second embodiment of environmentally sensitive valve 228 is shown. Nozzle 218b is similar to nozzle 118b and valve 228 is similar to valve 128. Valve 228 also includes sealing member or thin polymeric sealing member 236 that contains temperature sensitive component 238 in the form of a liquid, which has a boiling temperature lower than that of the fuel cell fuel.

Sealing member 236 is preferably formed of a polymeric material capable of expanding under pressure and returning to or towards its original shape. In addition, the polymeric material forms a seal when in contact under pressure with inner surface of nozzle 218b. One suitable commercially available polymeric material is low-density polyethylene (LDPE), which can be continuously extruded in a tube and pinched or sealed at the ends 236a, using conventional techniques known by those of ordinary skill in the art. Continuous extrusion can reduce manufacturing costs. Alternatively, sealing member 236 can be formed by blow molding using conventional techniques known by those of ordinary skill in the art. Blowmolding containers of liquid or fuel, including the application of coatings of thin films to reduce vapor permeation rate, is fully disclosed in commonly owned, co-pending application entitled “Fuel Supplies for Fuel Cells,” filed on Aug. 6, 2004, bearing Ser. No. 10/913,715, which is incorporated by reference herein in its entirety. Additional commercially available polymeric materials useful with the present invention are Teflon®, high-density polyethylene (HDPE), polypropylene (PP), and silicon. Sealing member 236 can be covered with an elastomeric material so that there are no seams on the exterior of valve 228.

Referring to FIGS. 5 and 6, valve 228 operates similarly to valve 128. In an open or unactuated state (as shown in FIG. 5), flow of fuel F is unobstructed. Valve 228 is sensitive to pressure caused by the velocity of the fuel F on sealing member 236. As a result, sealing member 236 can sealably contact sealing surface 232a. Similarly, valve 228 can be modified so that valve 228 does not exhibit or exhibits a reduced sensitivity to pressure, as discussed above.

Valve 228 is also sensitive to temperature. When the temperature sensitive component 238 is exposed to a temperature equal to or greater than the predetermined threshold temperature, at least some of temperature sensitive material 238 goes into a gaseous state and increases in volume within sealing member 236. As a result, sealing member 236 expands and contacts sealing surface 232b within second section 232. The internal pressure from liquid 238 allows a sealing contact to occur between sealing member 236 and sealing surface 232b. Consequently, valve 228 is in an actuated or closed state (as shown in FIG. 6) and the flow of fuel F from fuel chamber 20 to fuel cell FC is reduced or prevented.

After actuation, when the temperature decreases below the predetermined threshold temperature, temperature sensitive material 238 returns to its liquid state and the internal pressure within sealing member 236 reduces, allowing sealing member 236 to return to or towards its original shape and volume. Thus, valve 228 can return to the open or unactuated state (as shown in FIG. 5). Valve 228 may also include return springs and/or bypass flow channels, discussed above, to reduce pressure sensibility.

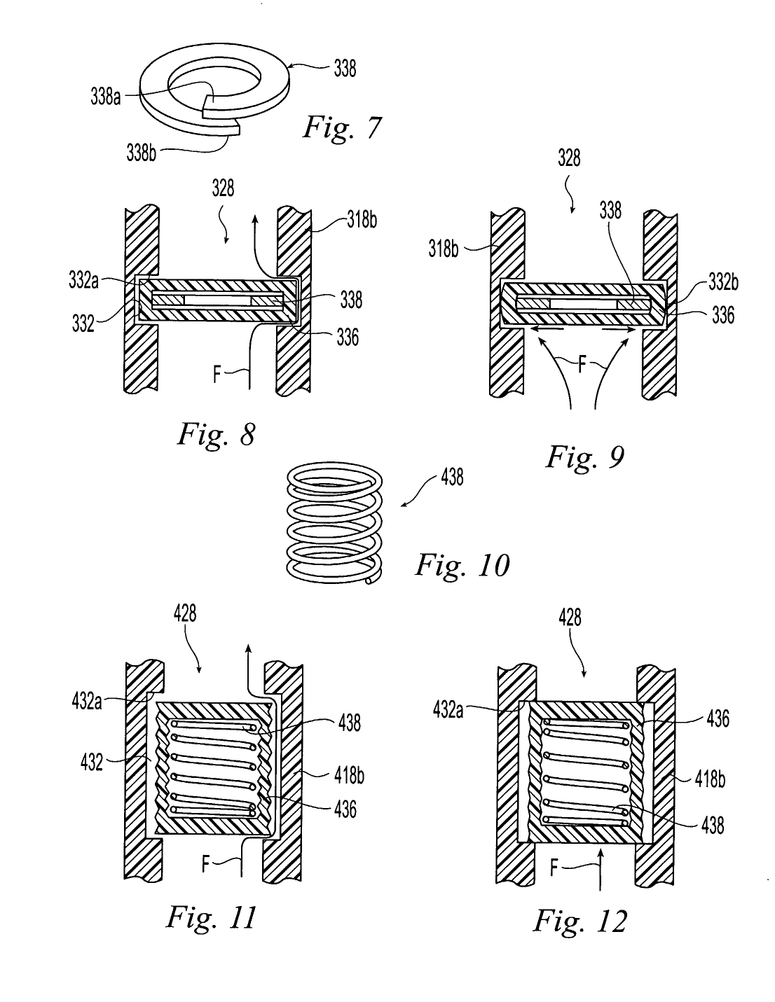

Referring to FIGS. 7-9, a third embodiment of environmentally sensitive valve 328 is shown. Nozzle 318b is similar to nozzle 118b. Valve 328 includes sealing member or elastomeric casing 336 that contains temperature sensitive material 338. Sealing member 336 is preferably formed of an elastomeric material similar to sealing member 136.

In this embodiment, temperature sensitive material 338 is preferably in the form of a bimetallic spring that changes shape with a temperature equal to or greater than the predetermined threshold temperature. Spring 338 preferably has free ends 338a,b that overlap so that the spring is a generally closed loop with at least one coil. One specific preferable material for forming the bimetallic spring is an austentic material memory wire, discussed below. In an alternative embodiment, temperature sensitive material 338 can be an expanding material that exhibits significant volume changes with changes in temperature. Alternatively, the expanding material is a wax, such as a polymer blend, a wax blend, or a wax/polymer blend. This material should expand in volume when it melts at the predetermined threshold temperature.

Referring to FIGS. 7-9, in an open or unactuated state (as shown in FIG. 8), fuel flow F is unobstructed. Valve 328 is sensitive to pressure caused by fuel flow F. When the fuel flow is below a predetermined level, the fuel applies pressure on valve 328 but sealing member 336 does not move into sealing contact with sealing surface 332a. Once the fuel flow exceeds the predetermined threshold, valve 328 is actuated and sealing member 336 is moved and forced into sealing contact with sealing surface 332a to reduce or prevent fuel flow. Valve 328 may also include return springs and/or bypass flow channels to reduce pressure sensitivity, discussed above.

Valve 328 is also sensitive to temperature. When temperature sensitive material 338 is exposed to a temperature equal to or greater than the predetermined threshold temperature, bimetallic spring 338 expands within the casing 336. As a result, casing 336 expands and contacts sealing surface 332b within second section 332 of nozzle 318b. The pressure from spring 338 allows a sealing contact to occur between casing 336 and sealing surface 332b. Consequently, valve 328 is in an actuated or closed state (as shown in FIG. 9) and fuel flow F from fuel chamber 20 to fuel cell FC is reduced or prevented.

After actuation, when the temperature experienced by temperature sensitive material or spring 338 decreases below the predetermined threshold temperature, the spring 338 returns to or towards its original state and the casing 336 returns to or towards its original shape and volume. Thus, valve 328 can return to the open or unactuated state (as shown in FIG. 8).

Referring to FIGS. 10-12, a fourth embodiment of environmentally sensitive valve 428 is shown. Nozzle 418b is similar to nozzle 118b. Valve 428 includes sealing member or elastomeric casing 436 that contains temperature sensitive material 438. Sealing member 436 is preferably formed of an elastomeric material similar to casing 136 and has non-linear sidewalls to allow for thermal expansion.

Temperature sensitive material 438 is preferably in the form of a bimetallic spring that changes shape with a temperature equal to or greater than that the predetermined threshold temperature. In this embodiment, spring 438 is a helical spring. Spring 438 is preferably formed of the same materials as spring 338, previously discussed.

Referring to FIGS. 10-12, in an open or unactuated state (as shown in FIG. 11), fuel flow F is unobstructed. Valve 428 is sensitive to pressure caused by the velocity of fuel flow F, similar to valve 328, previously discussed.

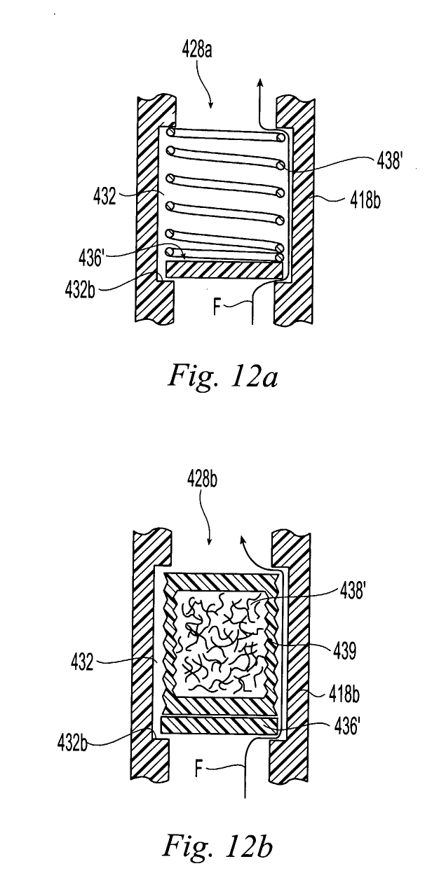

Valve 428 is also sensitive to temperature. When temperature sensitive material 438 is exposed to a temperature equal to or greater than the predetermined threshold temperature, valve 428 is actuated and bimetallic spring 438 expands within casing 436 in the direction of fuel flow F. As a result, casing 436 expands and contacts sealing surface 432a within second section 432. The pressure from spring 438 allows a sealing contact to occur between casing 436 and sealing surface 432a. Consequently, valve 428 is in an actuated or closed state (as shown in FIG. 12) and fuel flow F from fuel chamber 20 to fuel cell FC is reduced or prevented.

After actuation, when the temperature experienced by temperature sensitive component or spring 438 decreases below the predetermined threshold temperature, spring 438 returns to or towards its original state and sealing member 436 returns to or towards its original shape and volume. Thus, valve 428 returns to the open or unactuated state (as shown in FIG. 11). Valve 428 may also include return springs and/or bypass flow channels to reduce pressure sensibility, discussed above.

An alternative embodiment of valve 428a is shown in FIG. 12a. Valve 428a is similar to valve 428 except sealing member 436′ is a disk of elastomeric material that can sealably contact sealing surface 432b if temperature sensitive component or bimetallic spring 438′ is actuated. Spring 438′ is not enclosed within a casing. Yet another alternative embodiment of valve 428b is shown in FIG. 12b. Valve 428b is similar to valve 428 except sealing member 436′ is a disk of elastomeric material that can sealably contact sealing surface 432b if temperature sensitive component 438′ is actuated. Component 438′ is an expanding material enclosed within elastomeric casing 439. The expanding material exhibits significant volume changes with changes in temperature. Preferably, the expanding material is a wax, such as a polymer blend, a wax blend, or a wax/polymer blend. The expanding material can also be a gas. This material should expand in volume during and/or after the melting of the wax at the predetermined threshold temperature. Valve 428b is sensitive to changes in pressure similar to valve 428. Alternatively, valve 428b may include a return spring and/or bypass flow channels, discussed above.

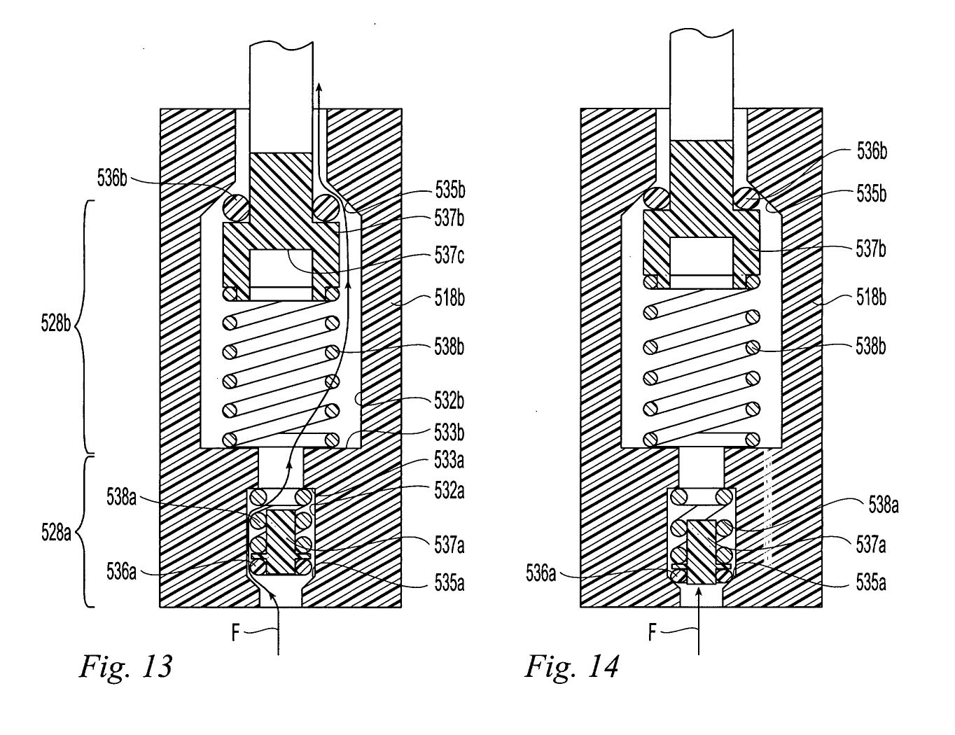

FIGS. 13-14 illustrate a fifth embodiment of environmentally sensitive valves 528a,b. Nozzle 518b is similar to nozzle 118b, however, nozzle 518b includes two enlarged sections 532a and 532b with seating portions 533a, 533b and sealing surfaces 535a, 535b. The valve bodies can be made integral to each other as shown, or can be made separately and assembled.

Each valve 528a,b includes respective sealing member or elastomeric o-ring 536a,b supported by respective movable plunger 537a,b. Suitable commercially available materials for sealing members 536a,b are ethylene propylene diene methylene terpolymer (EPDM) rubber, ethylene-propylene elastomers, Teflon®, and Vitrons fluoro-elastomer. Preferably, EPDM is used.

Each valve 528a,b further includes respective temperature sensitive components 538a,b, in the form of a multi-coiled bimetallic spring. Each spring 538a,b changes shape with a temperature. Springs 538a,b are preferably formed of the same materials as spring 338.

In valve 528a, spring 538a is disposed between seating surface 533a and plunger 537a and is operatively associated with plunger 537a. Preferably, spring 538a is coupled to seating surface 533a and plunger 537a so that valve 538a can operate in any orientation. In valve 528b, spring 538b is disposed between seating surface 533b and plunger 537b and is operatively associated with plunger 537b. Preferably, spring 538b is coupled to seating surface 533b and plunger 537b so that valve 538b can operate in any orientation.

Referring to FIGS. 13-14, in an open or unactuated state (as shown in FIG. 13), springs 538a,b are sized and dimensioned such that o-rings 536a and 536b do not seal, and fuel flow F is unobstructed. Valve 528b is sensitive to pressure caused by the velocity of fuel flow F on valve 528b. When the fuel flow is below a predetermined threshold, fuel F can move plunger 537b but not so that o-ring 536b is sufficiently compressed against sealing surface 535b to create a seal. As a result, fuel can flow through o-ring 536b.

Once fuel flow F exceeds the predetermined threshold level, valve 528b is actuated by the surge of pressure against plunger surface 537c and plunger 537b is moved to compress o-ring 536b into sealing contact with sealing surface 535b. As a result, valve 528b is in a closed or actuated state. Once the pressure decreases below the threshold pressure, valve 528b automatically returns to the open or unactuated state (as shown in FIG. 13).

Valves 528a,b are also sensitive to temperature. When temperature sensitive components 538a,b are exposed to a temperature equal to or greater than the predetermined threshold temperature, valves 528a,b are actuated and bimetallic springs 538a,b expand against their associated seating portions 533a,b. As a result, springs 538a,b move associated plungers 537a,b so that o-rings 536a,b contact and are significantly compressed against sealing surfaces 535a,b, respectively. Consequently, valves 528a,b are in an actuated or closed state (as shown in FIG. 14) and fuel flow F from fuel chamber 20 to fuel cell FC is reduced or prevented.

After actuation, when the temperature experienced by temperature sensitive component or springs 538a,b decreases below the predetermined threshold temperature, springs 538a,b return to or towards their original state and plungers 537a,b return to or towards their original positions. Thus, valves 528a,b return to or towards the open or unactuated state (as shown in FIG. 13). Optionally, return spring(s) can be used to return valves 528a,b to the unactivated state.

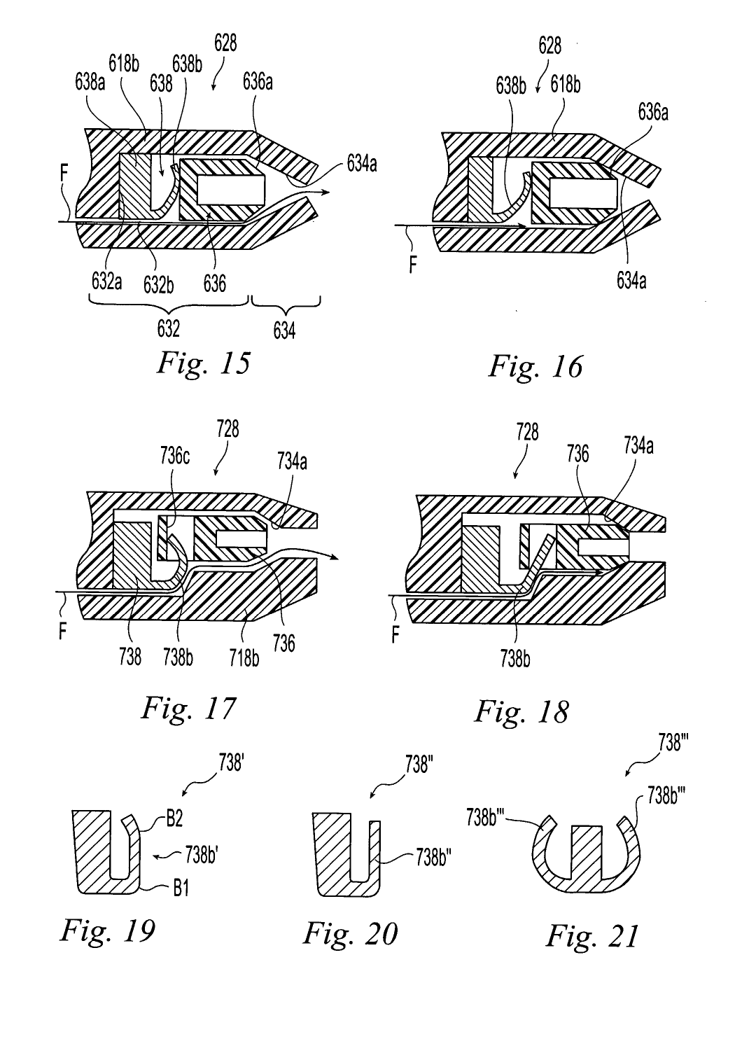

Referring to FIGS. 15-16, a sixth embodiment of environmentally sensitive valve 628 is shown. Nozzle 618b includes a bore with enlarged diameter section 632 and downstream tapered diameter section 634. Enlarged diameter section 632 includes seating surface 632a with at least one opening 632b for allowing fluid communication between fuel chamber 20 and section 632. Additional openings 632b can be provided or the geometry of opening 632b can be changed to provide the necessary fuel flow rate. Tapered diameter section 634 includes sealing surface 634a.

Valve 628 includes sealing member or elastomeric plug 636 that is operatively associated with temperature sensitive component 638. Plug 636 is preferably formed of an elastomeric material similar to sealing member 136. Plug 636 has a generally cylindrical shape. Plug 636 preferably includes tapered outer surface 636a at the downstream end.

Temperature sensitive component 638 is preferably in the form of a bimetallic spring that changes shape with temperature. Spring 638 includes base 638a and outwardly extending curved cantilevered arm 638b that contacts plug 636. Base 638a of spring 638 contacts seating surface 632a so that opening 632b is unobstructed. In an open or unactuated state (as shown in FIG. 15) fuel flow F is uninhibited because outer surface 636a of plug 636 is spaced from sealing surface 634a.

Valve 628 is sensitive to temperature. When temperature sensitive component or spring 638 is exposed to a temperature equal to or greater than the predetermined threshold temperature, valve 628 is actuated and bimetallic spring 638 expands and arm 638b moves away from base 638a. As a result, spring 638 moves plug 636 so that outer surface 636a contacts and is sufficiently compressed against sealing surface 634a to form a seal. Consequently, valve 628 is in an actuated or closed state (as shown in FIG. 16) and fuel flow F from fuel chamber 20 (See FIG. 1) to fuel cell FC is reduced or prevented.

If valve 628 is to automatically return to or towards its original state when temperature decreases, the material for spring 638 should be selected to exhibit the necessary memory characteristics. Alternatively, base 638a of spring 638 can be omitted and arm 638b is anchored to sealing surface 632a. Also, base 638a and arm 638b can be made integral to each other or can be made separately and joined together.

Referring to FIGS. 17-18, a seventh embodiment of temperature sensitive valve 728 is shown. Nozzle 718b is similar to nozzle 618b. In valve 728, sealing member or plug 736 further includes retention bore 736c near an upstream end. Arm 738b of temperature sensitive component or spring 738 extends through bore 736c and is coupled therewith. Valve 728 operates similarly to valve 628, except when the temperature decreases below the predetermined threshold temperature, arm 738b of spring 738 returns to or towards its original state pulling plug 736 back to or towards its original position or open state (as shown in FIG. 17). Sealing members 726 and 626 can have other shapes, such as spherical, conical or hemispherical and a porous filter can be placed in flow path F to control the flow of fuel.

FIGS. 19-21 show alternative embodiments of temperature sensitive components 738′, 738″ and 738′″, respectively, for use in temperature sensitive valves 628, 728, 828, and 928. Temperature sensitive component 738′ has an arm 738b′ with two bends B1 and B2. On the other hand, component 738 (See FIG. 17) has a smoothly curving radius. Temperature sensitive component 738″ has an arm 738b″, which is substantially flat. Temperature sensitive component 738′″ has two opposing smoothly curved arms 738b′″. This provides an increased force during actuation as compared to the temperature sensitive components with only one arm. The geometry of the arms of spring 738′″ can also have the double bends of spring 738′ or the flat profile of spring 738″. The geometry of temperature sensitive component 738, 738′, 738″ and 738′″ will depend on the desired force during actuation.

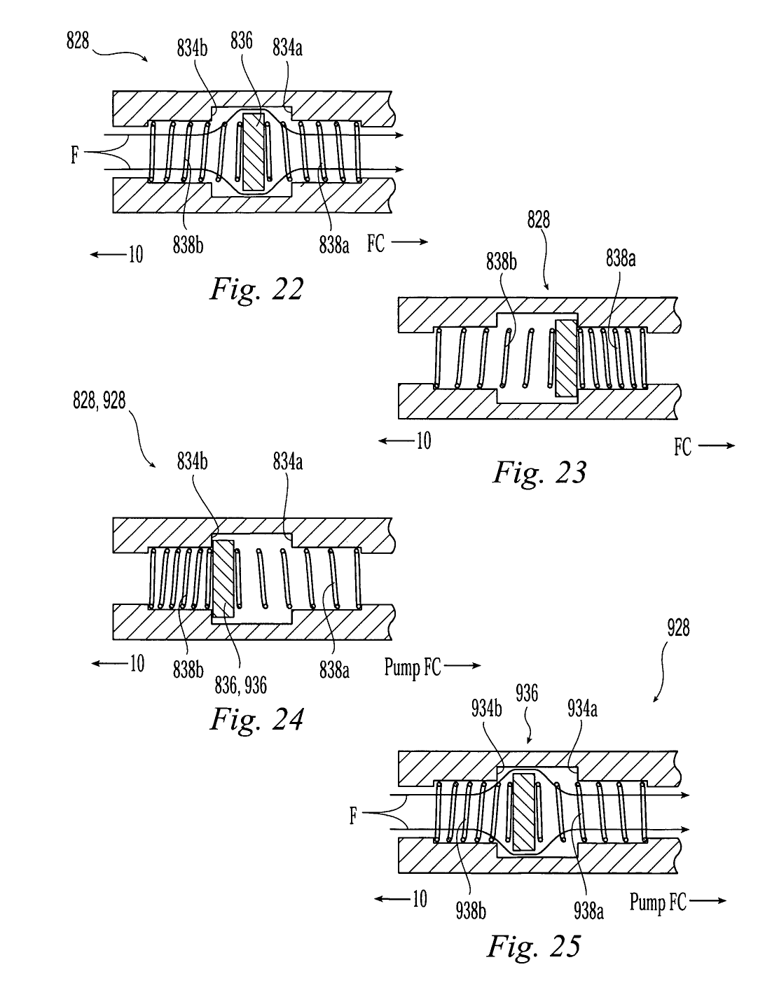

Referring to FIGS. 22-24, an eighth embodiment of the present invention is shown. Valve 828 comprises sealing member 836 adapted to cooperate with either surface 834a or surface 834b to close valve 838. Sealing member 836 is held in position by springs 838a and 838b. Sealing surface 834a and spring 838a are closer to the fuel cell, and sealing surface 834b and spring 838b are closer to fuel cartridge 10, as shown.

In one scenario, valve 838 is a temperature sensitive valve, and spring 838b is a bimetallic spring or otherwise has a substantially higher coefficient of thermal expansion than spring 838a. When the predetermined temperature is reached, spring 838b expands and overcomes spring 838a to seal the valve as shown in FIG. 23. Alternatively, valve 828 is a pressure sensitive valve and the spring constant of springs 838a and 838b is selected such that at a predetermined pressure or velocity of the fuel flow, the flow compresses spring 838a and extends spring 838b to seal valve 828, also as shown in FIG. 23. When valve 828 is a pressure sensitive valve, the spring constants of spring 838a and 838b can be substantially the same. In another scenario, the spring constant of spring 838b can be selected so that sealing member 836 cooperates with sealing surface 834b to prevent a reverse flow of fuel from exiting the fuel cell. In this case, the spring constant of spring 838b is preferably small such that a small amount of reverse flow shuts off valve 828 as depicted in FIG. 24.

Referring to FIGS. 24-25, a ninth embodiment of the present invention is shown. Valve 928 is similar to valve 828 in that it can be a pressure sensitive valve and/or a temperature sensitive valve, except that in the unactuated position, shown in FIG. 24, valve 928 is closed and a pump is needed to open valve 928 to allow fuel flow as shown in FIG. 25. An advantage of valve 928 is that when the pump is turned off and the fuel cell is turned off, valve 928 also shuts off to prevent reverse flow. Alternatively, in the unactuated position, shown in FIG. 25, sealing member 936 is eccentrically located between sealing surfaces 934a and 934b, preferably closer to surface 934b, which is closer to fuel cartridge 10. The distance between sealing member 936 and sealing surface 934b and the spring constant of spring 938b are selected to close valve 928 (e.g., see FIG. 24) to prevent reverse flow. This distance may need to be relatively small and the spring constant may need to be weak to respond adequately to the low velocity of the reverse flow.

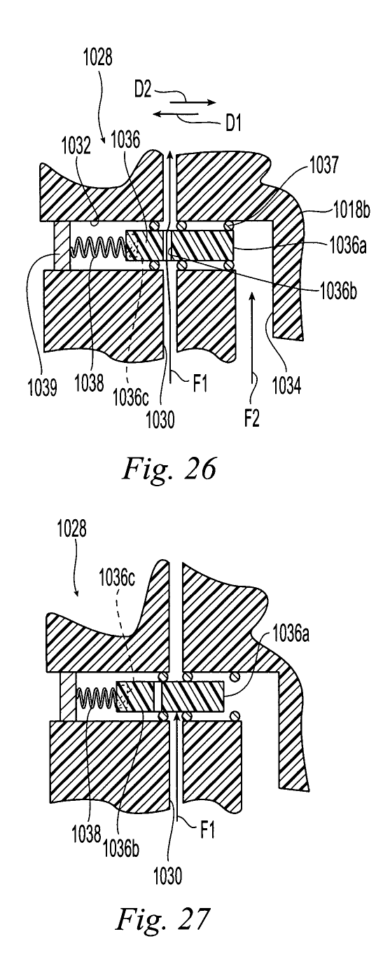

Referring to FIGS. 26-27, a tenth embodiment of environmentally sensitive valve 1028 is shown. Nozzle 1018b includes first channel 1030, second channel 1032, and third channel 1034. First and third channels 1030 and 1034 are perpendicular to second channel 1032. Channels 1030, 1032 and 1034 are all in fluid communication with fuel chamber 20 (shown in FIG. 1).

Valve 1028 includes sealing member or plug 1036 formed of an elastomeric material similar to casing 136. Plug 1036 includes outer surface 1036a, flow bore 1036b, and retention bore 1036c. Plug 1036 is disposed within second channel 1032 and is supported by a plurality of wipers 1037 in nozzle 1018b. Wipers or seals 1037 assist in allowing movement of plug 1036 within second channel 1032 along directions illustrated by arrows D1 and D2. Valve 1028 further includes coiled spring 1038. Spring 1038 is supported against stop 1039 at one end and is received within retention bore 1036c.

Referring to FIGS. 26-27, in an open state (as shown in FIG. 26) flow bore 1036b aligns with first channel 1030, and fuel flow F1 is unobstructed and can pass through first channel 1030 via flow bore 1036b. Valve 1028 is sensitive to the pressure caused by the velocity of the fuel flow, as shown by the pressure of fuel F2 on valve 1028. When the fuel flow is below a predetermined threshold, spring 1038 is not compressed sufficiently so that fuel can flow through bore 1036b, as shown in FIG. 26. Once the fuel flow exceeds the predetermined threshold pressure, pressure from fuel F2 in second channel 1032 pushes against plug surface 1036a. This causes plug 1036 to move in direction D1 and compress spring 1038. As a result, flow bore 1036b is unaligned with first channel 1030 preventing flow. Valve 1028 automatically resets once pressure is reduced because spring 1038 can return plug 1036 to the open state.

Valve 1028 is also sensitive to temperature, when spring 1038 is temperature sensitive. At temperatures above threshold, bimetallic spring 1038 contracts against stop 1039. As a result, spring 1038 compresses and moves plug 1036 in direction D1 so that flow bore 1036b is unaligned with first channel 1030 preventing flow (as shown in FIG. 27). Alternatively, spring 1038 can also expand to unalign flow bore 1036b. Spring 1038 can be made from a bimetallic material.

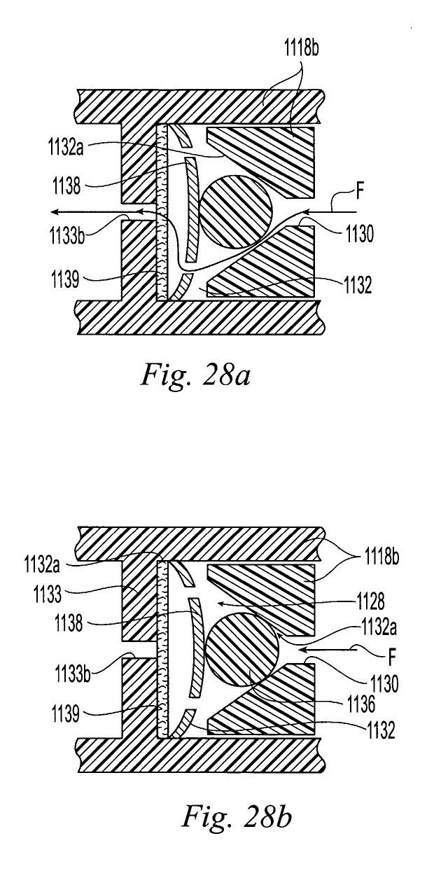

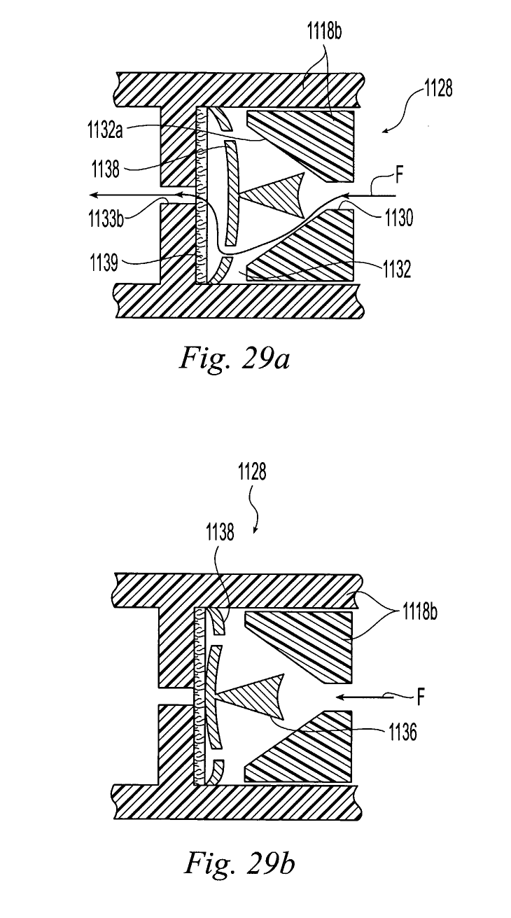

Referring to FIGS. 28a-28b and 29a-29b, an eleventh embodiment, environmentally sensitive valve 1128, is shown. Nozzle 1118b has first section 1130 and enlarged second section 1132. Second section 1132 includes sealing surface 1132a. Second section 1132 further includes seating portion 1133 with an orifice 1133b therethrough.

Valve 1128 includes sealing member or plug 1136 formed of an elastomeric material. Valve 1128 further includes temperature sensitive component 1138, which preferably is a bimetallic washer/spring. Spring 1138 is shaped like a parabolic disk in the open state and flattens when actuated. Alternatively, spring 1138 can be flat when in the open or unactuated state and can bow into a parabolic disk shape when actuated. Spring 1138 changes shape with a temperature equal to or greater than the predetermined threshold temperature, as previously discussed with respect to spring 338. Spring 1138 is supported by seating portion 1133. Plug 1136 can be a sphere and is unattached to spring 1138, as shown in FIGS. 28a and 28b, or plug 1136 has a blunt leading edge and is fixedly attached to spring 1138, as shown in FIGS. 29a and 29b. Valve 1138 may include porous filler 1139 to control flow. In the present embodiment, filler 1139 is shown upstream of spring 1138. In an alternative embodiment, filler 1139 can be located downstream of spring 1138.

Referring to FIGS. 28a and 29a, in an open state, fuel flow F is unobstructed. Valve 1128 is sensitive to pressure caused by the velocity of the fuel flow due to the blunt leading edge of plug 1136. When the fuel flow is below a predetermined threshold, washer 1138 is not fully compressed so that plug 1136 is spaced from surface 1132a. As a result, fuel can flow through valve 1128.

Once the fuel flow exceeds the predetermined threshold, fuel flow F presses against the blunt leading edge of plug 1136 and compresses spring 1138 to fully or partially block orifice 1133b to reduce or prevent flow, as shown in FIG. 29b. When filler 1129 is positioned as shown in FIG. 29b, flow channel through orifice 1133b is only partially blocked.

Valve 1128 can also be sensitive to temperature. When washer 1138 is exposed to a temperature equal to or greater than the predetermined threshold temperature, bimetallic washer 1138 expands and moves plug 1136 into contact with surface 1132a and compresses plug 1136 against surface 1132a. Consequently, valve 1128 is closed (as shown in FIG. 28b) and fuel flow is reduced or prevented.

When the temperature decreases below the predetermined threshold temperature, spring 1138 returns to or toward its original state and plug 1136 can return to or towards its original position. If valve 1128 is to automatically return to or towards its original state, as discussed above, the material for spring 1138 should be selected to exhibit the necessary memory characteristics. Valve 1128 can be modified to include a return spring downstream of plug 1136 similar to valve 128d (in FIG. 4c) to assist in returning valve 1128 to its original state after temperature actuation.

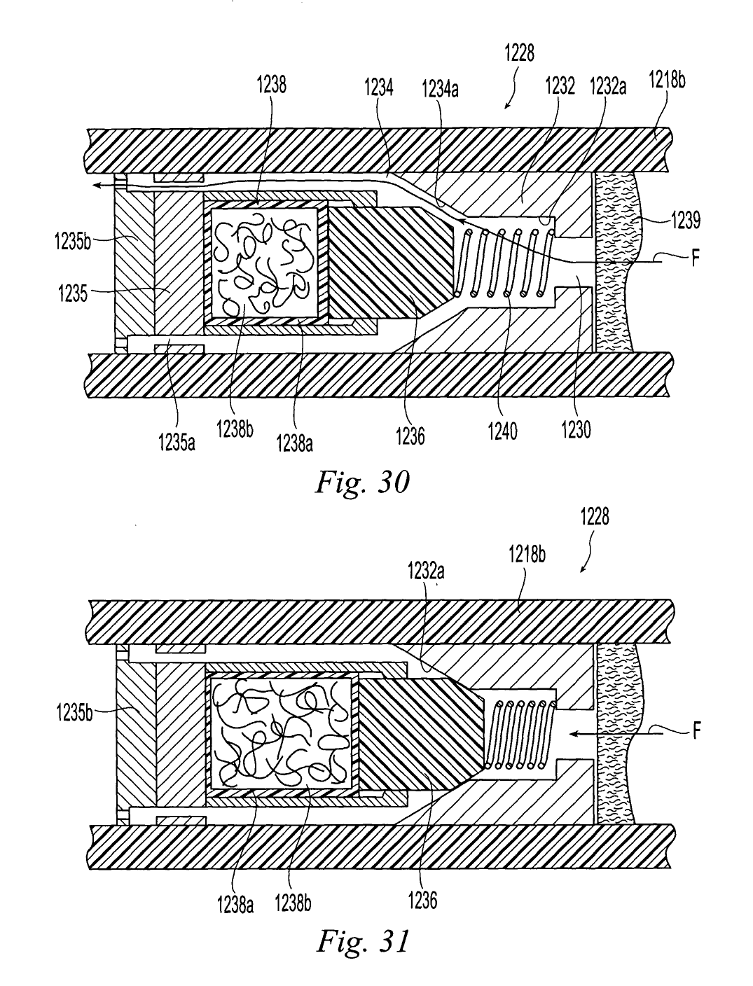

Referring to FIGS. 30-31, a twelfth embodiment of environmentally sensitive valve 1228 is shown. Nozzle 1218b has first section 1230, second section 1232, and third section 1234. Second section 1232 includes bore 1232a. Third section 1234 includes sealing surface 1234a. The third section 1234 further includes seating portion 1235 with orifices 1235a therethrough and support 1235b for supporting the remaining components of valve 1228. Support 1235b can be attached to nozzle 1018b by various means, including but not limited to, press-fitting, welding, ultrasonic welding, adhesives, etc.

Valve 1228 includes sealing member or plug 1236 formed of an elastomeric material similar to casing 136, previously discussed. Valve 1228 further includes temperature sensitive component 1238, porous filler 1239 and return spring 1240.

Temperature sensitive component 1238 includes elastomeric casing 1238a containing expanding material 1238b that exhibits significant volume changes with changes in temperature. Preferably, the expanding material is a wax, such as a polymer blend, a wax blend, or a wax/polymer blend. The expanding material can also be a gas. This material should expand in volume after it melts at the predetermined threshold temperature. Alternatively, a liquid discussed above with a boiling point below the threshold temperature can be the temperature sensitive component. Preferably, the wax used can expand about 10% to about 15% of an initial volume when a temperature at or above the threshold temperature is experienced. Alternatively, elastomeric casing 1238a can be omitted and wax 1238b can directly contact sealing member 1236.

Referring to FIGS. 30-31, in an open or unactuated state (as shown in FIG. 30), return spring 1240 biases plug 1236 away from sealing surface 1234a so that fuel flow F is allowed. When the temperature sensitive component or spring 1238 is exposed to a temperature equal to or greater than the predetermined threshold temperature, temperature sensitive component 1238b expands, thus expanding casing 1238a. This expansion is sufficient to overcome the spring force exhibited by return spring 1240 so that plug 1236 moves into contact with and is sufficiently compressed against sealing surface 1234a to create a seal. Consequently, valve 1228 is in closed state (as shown in FIG. 31) and fuel flow F from fuel chamber 20 (See FIG. 1) to fuel cell FC is reduced or prevented.

When the temperature decreases below the predetermined threshold temperature, temperature sensitive component 1238b and casing 1238a return to or towards their original state, and the force of return spring 1240 moves plug 1236 back to or towards its original position. As a result, valve 1228 returns to the open state (as shown in FIG. 30) allowing fuel to flow. The embodiments of FIGS. 15-18, 22a-22b, 23a-23b and 24-25 may include a return spring similar to return spring 1240.

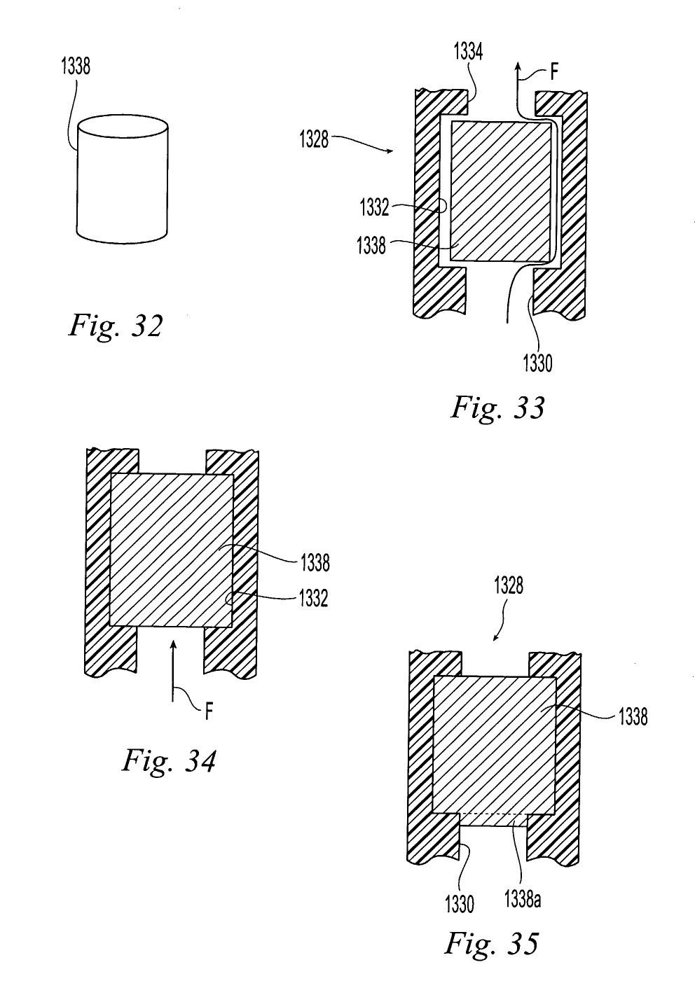

Referring to FIGS. 32-35, a thirteenth embodiment of environmentally sensitive valve 1328 is shown. Nozzle 1318b includes first, second and third sections 1330, 1332, and 1334. Valve 1328 includes temperature sensitive sealing member or plug 1338 capable of changing in volume with temperature. Plug 1338 is disposed and held within second section 1332 of nozzle 1318b. Preferably, plug 1338 is a material that expands when temperature increases. Plug 1338 also is capable of sealing against fuel flow. Although plug 1338 is shown with a cylindrical shape, the present invention is not limited thereto. Alternatively, plug 1338 can be formed of an expanding material within a casing like spring 1238, discussed above. Preferably, the plug is made from a material with high thermal expansion, e.g., aluminum, and the nozzle is made from a material with low thermal expansion, so that the plug thermally expands faster than the nozzle to seal the valve.

Valve 1328 operates similarly to valve 128. Referring to FIGS. 33-35, in an open state (as shown in FIG. 33), fuel flow F is unobstructed. Valve 1328 is sensitive to pressure caused by the velocity of fuel flow F on valve 1328, similar to valve 128 previously discussed. Valve 1328 is also sensitive to temperature. When the temperature sensitive component or plug 1338 is exposed to a temperature equal to or greater than the predetermined threshold temperature, plug 1338 increases in volume. As a result, plug 1338 contacts or fills second section 1332 of nozzle 1318b. The pressure from expansion allows a sealing contact to occur between plug 1338 and nozzle 1318a reducing or preventing flow, as shown in FIG. 34. When the temperature experienced by the temperature sensitive component or plug 1338 decreases below the predetermined threshold temperature, the plug returns to or towards its original state and volume, and valve 1328 can return to the open state (as shown in FIG. 33).

FIG. 35 shows valve 1328 of FIGS. 32-34 where the material for plug 1338 additionally includes the characteristic of having a softening temperature equal to or less than the predetermined threshold temperature. As a result, when the predetermined threshold temperature is reached, not only does plug 1338 expand to seal valve, but a portion 1338a of plug 1338 softens and deforms into first section 1330 of the nozzle to further seal valve 1328 from fluid flow. Valve 1328 may also include return spring and/or bypass flow channels to reduce pressure sensitivity, discussed above.

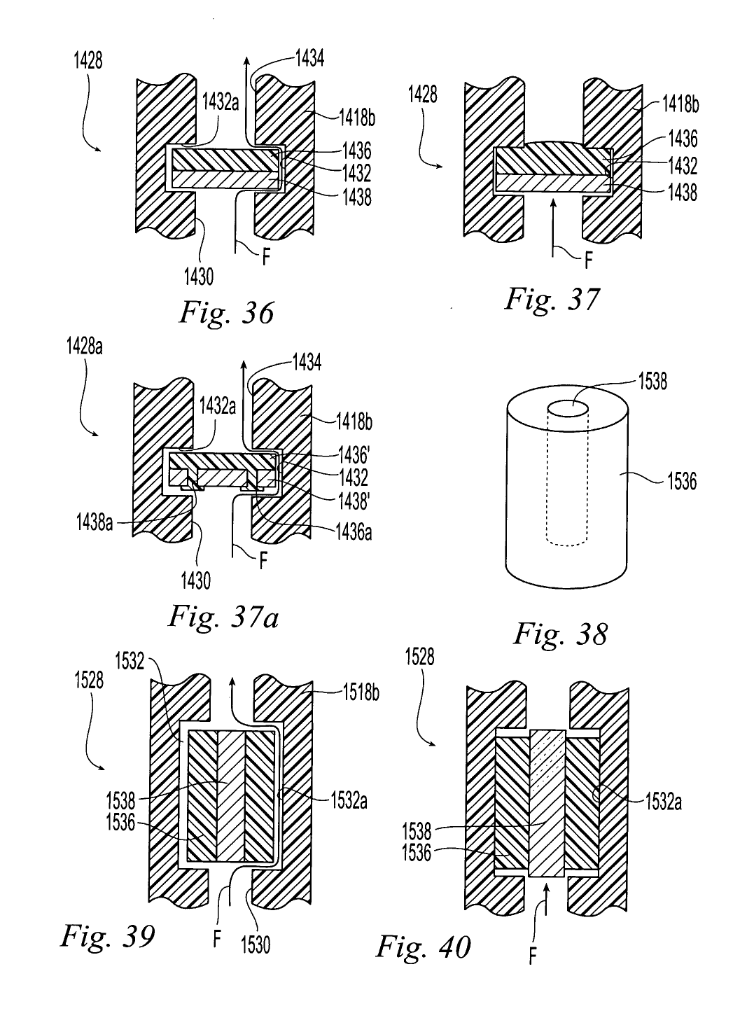

Referring to FIGS. 36-37, a fourteenth embodiment of environmentally sensitive valve 1428 is shown. Nozzle 1418b includes first, second and third sections 1430, 1432, and 1434, respectively. Valve 1428 includes sealing member or disk-shaped first plug 1436 and temperature sensitive component or disk-shaped second plug 1438. First plug 1436 is preferably formed of a sealing material such as an elastomeric material. Second plug 1438 is preferably formed of a temperature sensitive material similar to plug 1338, previously discussed, and is capable of changing volume with temperature. Valve 1428 is disposed within enlarged second section 1432 of nozzle 1418b. First and second plugs 1436 and 1438 are optionally coupled together by, for example, an adhesive.

Alternatively, as shown in FIG. 37a, valve 1428a can be modified so that first plug 1436 includes projections 1436a with enlarged ends that are received within bores 1438a of second plug 1438. The cooperation between projections 1436a and second plug 1438 mechanically interlock first and second plugs 1436,1438. In this embodiment, first and second plugs 1436, 1438 can be co-molded as well. In another alternative, first plug 1436 can include bores and second plug 1438 can include projections.

Referring again to FIG. 36, valve 1428 operates similarly to valve 1328. In an open or unactuated state (as shown in FIG. 36), fuel flow F is unobstructed. Valve 1428 is sensitive to pressure caused by the velocity of fuel flow F on valve 1428, similar to valve 128 previously discussed. Valve 1428 is also sensitive to temperature. When the temperature sensitive component or second plug 1438 is exposed to a temperature equal to or greater than the predetermined threshold temperature, second plug 1438 increases in volume. As a result, second plug 1438 pushes first plug 1436 into contact with sealing surface 1432a. The pressure from expansion allows a sealing contact to occur between first plug 1436 and nozzle 1418b. Consequently, valve 1428 is a closed state (as shown in FIG. 37) reducing or preventing fuel flow.

When the temperature decreases below the predetermined threshold temperature, second plug 1438 returns to or towards its original state and volume. This releases first plug 1436 from sealing contact. Thus, valve 1428 returns to the open state (as shown in FIG. 36).

Referring to FIGS. 38-40, a fifteenth embodiment of environmentally sensitive valve 1528 is shown. Nozzle 1518b includes first, second, and third sections 1530, 1532, and 1534, respectively. Valve 1528 includes sealing member or casing 1536 partially enclosing temperature sensitive component or plug 1538. Casing 1536 is preferably formed of a sealing material such as an elastomeric material. Casing 1536 is a hollow cylinder that receives or partially covers cylindrical plug 1538.

Plug 1538 is formed of a material capable of changing in volume with temperatures. Plug 1538 is preferably formed of a temperature sensitive material similar to plug 1338, previously discussed. Valve 1528 is disposed within enlarged second section 1532 of nozzle 1518b. Casing 1536 and plug 1538 can be formed by a two-shot molding process known by those of ordinary skill in the art. This molding process may also couple these components together. Alternatively, an adhesive can be used to couple these components, particularly when these components are made from metal. Coupling can also be done by snap-fitting or press-fitting.

Valve 1528 operates similarly to valve 1328. In an original or unactuated state (as shown in FIG. 39), fuel flow F is unobstructed. Valve 1528 is sensitive to pressure caused by the velocity of fuel flow F on valve 1528, similar to valve 128 previously discussed. Valve 1528 is also sensitive to temperature. When temperature sensitive component or plug 1538 is exposed to a temperature equal to or greater than the predetermined threshold temperature, plug 1538 increases in volume. As a result, plug 1538 expands casing 1536 into contact with sealing surface 1532a. The pressure from expansion allows a sealing contact to occur between casing 1536 and nozzle 1518b. Consequently, valve 1528 is in a closed state (as shown in FIG. 40), reducing or preventing flow.

When the temperature experienced by the temperature sensitive component or plug 1538 decreases below the predetermined threshold temperature, plug 1538 and casing 1536 return to or towards their original states and volumes. This releases casing 1536 from sealing contact. Thus, valve 1528 can return to the open or unactuated state (as shown in FIG. 39).

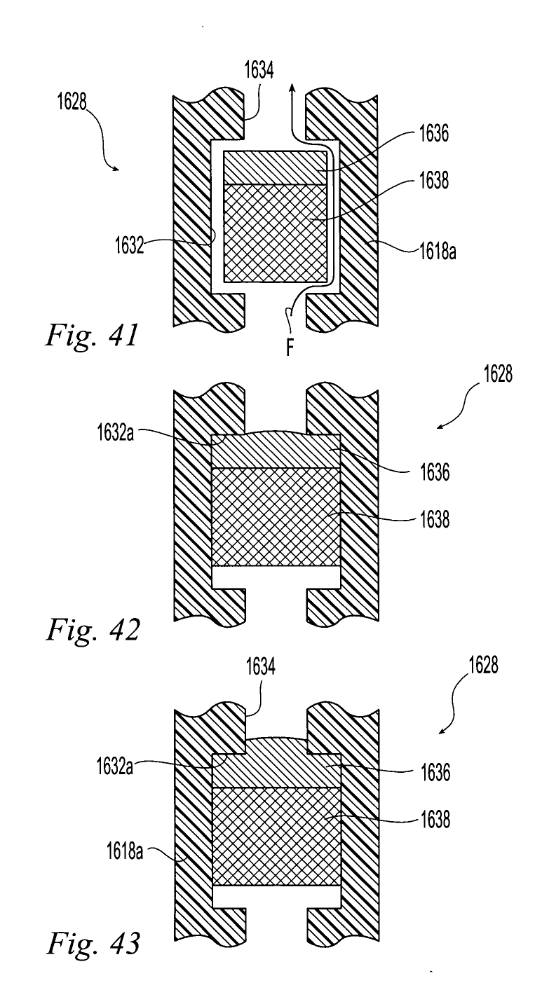

Referring to FIGS. 41-43, a sixteenth embodiment of temperature sensitive valve 1628 is shown. Nozzle 1618b includes first, second and third sections 1630,1632, and 1634, respectively. Valve 1628 includes sealing/temperature sensitive component or first plug 1636 and temperature sensitive component or second plug 1638. First and second plugs 1636,1638 are both temperature sensitive components. First plug 1636 is capable of softening a predetermined amount with temperatures equal to or greater than a predetermined threshold temperature. First plug 1636 is preferably formed of a softening and sealing material such as a polymeric material. One commercially available material suitable for forming first plug 1636 is paraffin.

Second plug 1638 is capable of changing in volume with temperatures equal to or greater than a predetermined threshold temperature. Second plug 1638 is preferably formed of a temperature sensitive material similar to plug 1338, previously discussed. Alternatively, second plug 1638 can be formed of a temperature sensitive component such as a wax biasing member (e.g., member 438′ in FIG. 12b with casing enclosing wax), a bimetallic biasing member (e.g., member 438 in FIG. 11), or a temperature sensitive biasing foam.

Valve 1628 is disposed within second section 1632 of nozzle 1618b. First and second plugs 1436 and 1438 are optionally coupled together by, for example, an adhesive or include mechanically cooperative elements that are snap fit, press fit, or co-molded together (as in FIG. 37a).

In an open state (as shown in FIG. 41), fuel flow F is unobstructed. Valve 1628 is sensitive to pressure caused by the velocity of fuel flow F on valve 1628, similar to valve 128 previously discussed. Valve 1628 is also sensitive to temperature. When first and second plugs 1636,1638 are exposed to a temperature equal to or greater than the predetermined threshold temperature, first plug 1636 softens a predetermined amount and second plug 1638 increases in volume. As a result, second plug 1638 pushes first plug 1636 into contact with sealing surface 1632a (as shown in FIG. 42). The pressure from expansion of second plug 1638 allows a portion of softened first plug 1636 and deforms to enter nozzle section 1634 and a sealing contact occurs between first plug 1636 and nozzle 1618b. Consequently, valve 1628 is closed (as shown in FIG. 43) and fuel flow is reduced or prevented.

After actuation, when the temperature experienced by first and second plugs 1436, 1438 decreases below the predetermined threshold temperature, plugs 1436, 1438 return to or towards their original states and/or volumes. This releases first plug 1636 from sealing contact.

The embodiments of FIGS. 32-43 may include return springs similar to return springs 140, 141. Such return springs can be designed to remove the pressure sensitivity of such valves or can be designed to control the pressure sensitivity of such valves.

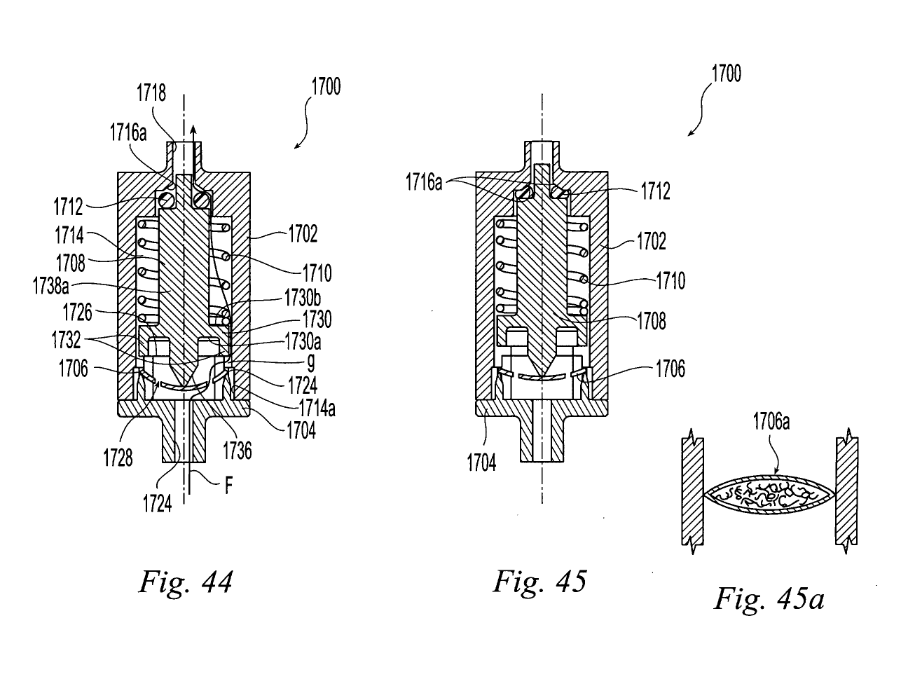

Referring to FIGS. 44 and 45, a seventeenth embodiment of environmentally sensitive valve 1700 is shown. Valve 1700 includes body 1702, cap 1704, temperature sensitive component 1706, plunger 1708, return spring 1710, and sealing member or o-ring 1712.

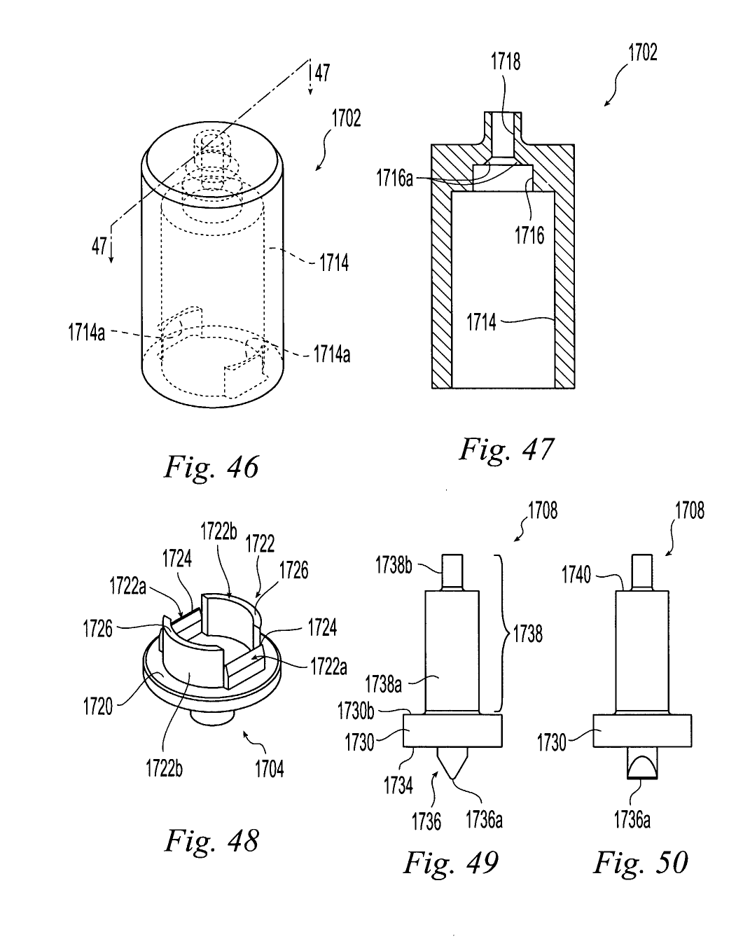

Referring to FIGS. 46 and 47, body 1702 includes stepped channels 1714, 1716, 1718. First channel 1714 is larger than second channel 1716. First channel 1714 further includes diametrically opposed recesses 1714a (best shown in FIG. 46). Second channel 1716 includes sealing surface 1716a. Third channel 1718 is an exit channel for fluid flowing through body 1702.

Referring to FIG. 48, cap 1704 includes base 1720 and sidewall 1722 extending outwardly from base 1720. Base 1720 further includes entrance channel 1724 (best seen in FIG. 44) therethrough. Sidewall 1722 has a plurality of diametrically opposed sidewall sections 1722a,b. First sidewall sections 1722a form spring supporting surfaces 1724. Second sidewall sections 1722b form stopping surfaces 1726. First sidewall sections 1722a are shorter than second sidewall sections 1722b. Referring to FIG. 44, when cap 1704 is installed into body 1702, second sidewall sections 1722b are received within recesses 1714a and gaps “g” are formed between spring supporting surfaces 1724 and plunger 1708.

Referring to FIG. 44, temperature sensitive component 1706 is a rectangular strip of a memory metal. Strip 1706 can be modified to have non-uniform thickness. Elliptical strip 1706a (as shown in FIG. 45a) with non-uniform thickness can be used and it can also contain temperature sensitive material. The present invention is not limited to the above-identified strip shapes.

Again with reference to FIG. 44, one preferred material for forming strip 1706 is an alloy such as a Nitinol or CuZnAl memory metal. Strip 1706 is preferably supported on spring supporting surfaces 1724 of first sidewall sections 1722a. Strip 1706 may define one or more openings 1728 to allow fluid flow there through. When the spring material is at room temperature, strip 1706 is in a “weakened” state and exhibits a weakened strain (about 6% for some NiTi metals). In the weakened state, strip 1706 is also in a martensite state and the flexural modulus is near the material's minimum value.

Referring to FIGS. 44, 49, and 50, plunger 1708 includes platform 1730 with first surface 1730a and second surface 1730b. First surface 1730a includes circumferentially extending sidewall 1732 with stop surface 1734 and spring contact member 1736. Spring contact member 1736 tapers to spring contact surface 1736a. Second surface 1730b of platform 1730 includes stepped stem 1738 with first stem section 1738a and second stem section 1738b. First and second stem sections 1738a,b are sized to form o-ring seat 1740.

Referring to FIGS. 44, 47, and 48, when plunger 1708 is installed within body 1702, first stem section 1738a of plunger 1708 is receivable within first and second channels 1714 and 1716. Second stem section 1738b of plunger 1708 is received within exit channel 1718.

Referring to FIG. 44, return spring 1710 is preferably disposed around first stem section 1738a of plunger 1708 within first channel 1714 of body 1702. Return spring 1710 contacts second surface 1730b of plunger platform 1730. Preferably, return spring 1710 is compressed and exerts a force, which produces a 6% strain on the strip 1706 in its “weakened” state. Referring to FIGS. 44 and 50, o-ring 1712 is preferably disposed on o-ring seating surface 1740 of the plunger.

The operation of valve 1728 will now be discussed with reference to FIGS. 44-45. In an open state (as shown in FIG. 44), fuel flow F is unobstructed. The spring constant of spring 1710 can be selected to let valve 1700 be pressure sensitive.

Valve 1728 is also sensitive to temperature. When the temperature is below the predetermined threshold temperature, valve 1728 is in open state (as shown in FIG. 44). In this state, strip 1706 is weakened so that return spring 1710 exerts sufficient force on plunger 1708, so that spring contact surface 1736a (See FIG. 50) contacts and bends strip 1706. O-ring 1712 is uncompressed (as shown). As a result, no seal is created between o-ring 1712 and sealing surface 1716a. Consequently, fuel F can flow through entrance channel 1724, orifices 1728 in strip 1706, gap g, first channel 1714, around plunger 1708, through o-ring 1712, and out exit chamber 1718 to fuel cell FC.

When temperature sensitive component or strip 1706 is exposed to a temperature equal to or greater than the predetermined threshold temperature, strip 1706 undergoes a state change and begins to seek its original flat state (as shown in FIG. 45). With the state change, strip 1706 is in an austenite state and the flexural modulus is approximately 2.5 times stiffer than in the martensite state. When nearly flattened, strip 1076 exerts a force on return spring 1710 through plunger 1708 that is greater than the return spring force. As a result, plunger 1708 moves within body 1702 and plunger 1708 compresses o-ring 1712 sufficiently to form a seal between o-ring 1712 and sealing surface 1716a. Thus, fuel flow is reduced or prevented. The strain on strip 1706 in the austenite state, which is about 2% to 3% for NiTi, provides a constant force exerted by strip 1706 on plunger 1708 to keep valve 1700 sealed at elevated temperatures.

As memory metal strip 1706 cools below the predetermined threshold temperature, strip 1706 changes back to the original “weakened” or martensite state and return spring 1710 can then move plunger 1708, and uncompresses o-ring 1712 to open valve 1700 allowing fuel to pass through. Thus, valve 1700 returns to the open state (as shown in FIG. 44) and automatically resets after the temperature drops below the predetermined temperature.

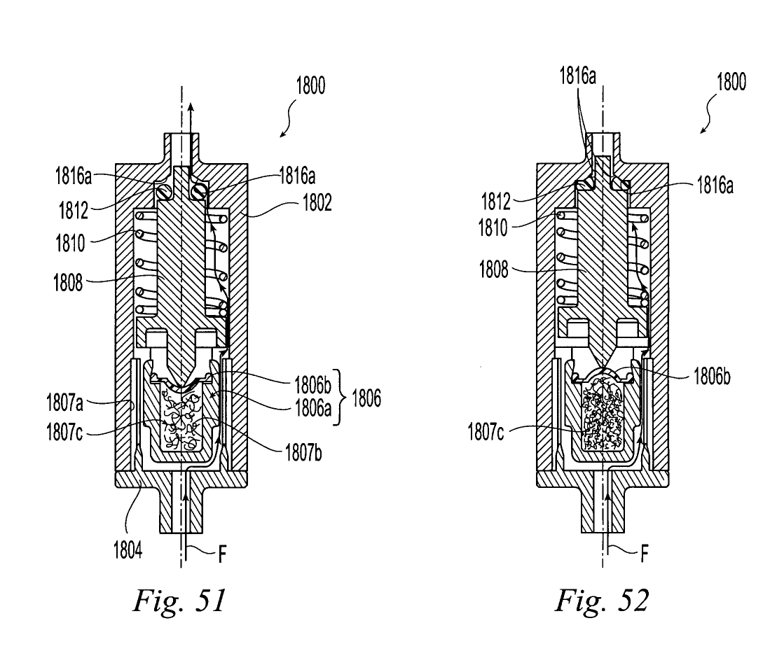

Referring to FIGS. 51-52, an eighteenth embodiment of environmentally sensitive valve 1800 is shown. Valve 1800 includes valve body 1802, cap 1804, plunger 1808, return spring 1810, and sealing member or o-ring 1812. Valve 1800 is similar to valve 1700, except for the temperature sensitive component.

Temperature sensitive component 1806 includes inner body 1806a and diaphragm 1806b. Inner body 1806a and valve body 1802 are configured and dimensioned so that at least one flow channel is defined therebetween. Inner body 1806a defines chamber 1807b with an upwardly extending opening. Chamber 1807b is filled with temperature sensitive wax 1807c. Upwardly extending opening of inner body 1806a is closed by expandable diaphragm 1806b coupled thereto. Diaphragm 1806b is preferably formed of an elastomeric material or metal capable of expanding under pressure and returning to or towards its original shape.

Valve 1800 operates similar to valve 1700. Valve 1800 is shown in the open state in FIG. 51 where diaphragm 1806b is bowed downward and return spring 1810 holds o-ring 1812 in an uncompressed state so that fuel flow F through valve 1800 is allowed. Due to the design of spring 1810 the valve 1800 is not pressure sensitive.

Valve 1800 is also sensitive to temperature. When the temperature rises to or above a predetermined threshold temperature, wax 1807c is heated to a melting temperature, liquefies and expands in the order of about 10% to about 15%. For other formulations the percentage expansion will vary. The expansion of wax 1807c causes diaphragm 1806b to expand and force plunger 1808 upward to compress return spring 1810 and o-ring 1812. As a result, a seal is created between o-ring 1812 and sealing surface 1816a and fuel flow is reduced or prevented through valve 1800. Wax 1807c is shown expanded with valve 1800 in closed state in FIG. 52.

As wax 1807c cools below the predetermined threshold temperature, wax 1807c reduces in volume and solidifies, and the force of return spring 1810 overcomes diaphragm 1806b, moves plunger 1808, and uncompresses o-ring 1812 to open valve 1800 allowing fuel to pass through. This process is repeatable. Wax 1807c can be replaced by any temperature sensitive materials discussed herein, such as bimetal springs or liquids with boiling points lower than that of the fuel.

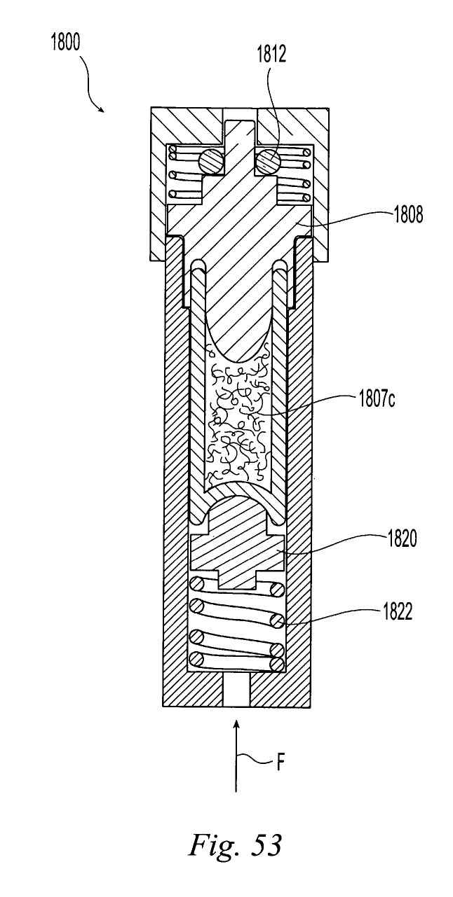

As shown in FIG. 53, diaphragm 1806b may be omitted and wax 1807c may expand and directly pushes plunger 1808 when there is a seal between the plunger and container of the wax. Plunger 1808 is biased and compresses o-ring 1812. Alternatively, o-ring 1812 can be omitted if plunger 1808 is made from sealing material. Also, valve 1800 may also have an optional over-travel plunger 1820 biased by spring 1822. The biased over-travel plunger absorbs some of the expansion from the wax so that o-ring 1812 is not over-compressed.

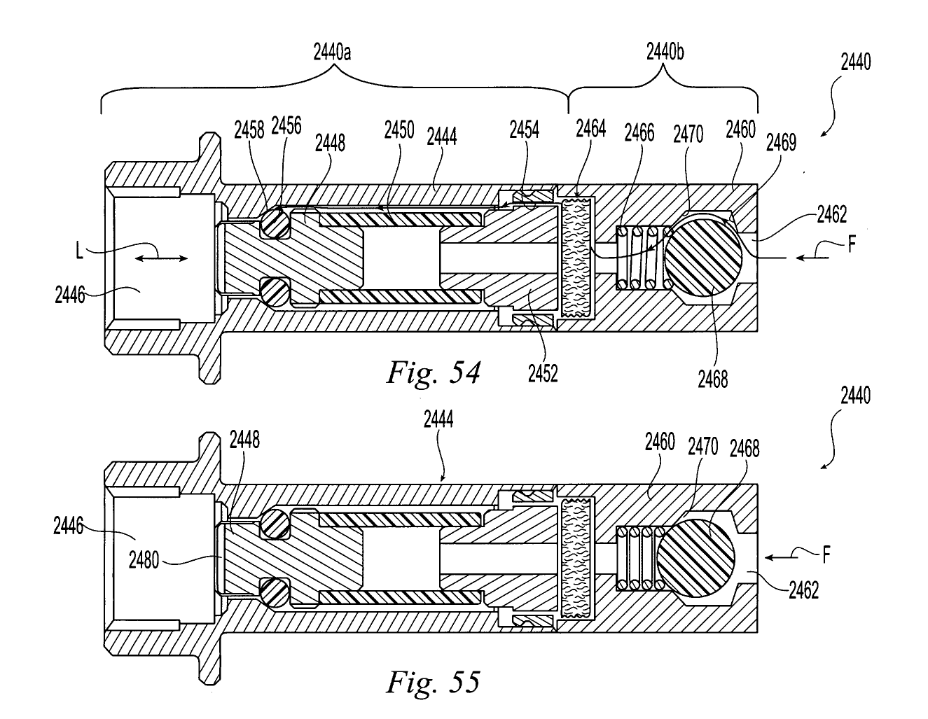

FIG. 54 illustrates a nineteenth embodiment of valve 2440. Valve 2440 comprises valve section 2440a and regulator valve section 2440b. Valve section 2440a is a component of a two-component valve fully disclosed in United States patent application publication no. US 2005/0022883, previously incorporated by reference. Valve section 2440a includes outer housing 2444 that defines opening 2446, which is configured to receive plunger 2448, spring 2450, stop 2452 and o-ring 2456. Stop 2452 acts as a bearing surface for spring 2450 and defines a plurality of openings 2454 in its periphery. In the sealing position, spring 2450 biases plunger 2448 and o-ring 2456 into sealing engagement with sealing surface 2458 of outer housing 2444. Spring 2450 can be formed of metal, elastomeric or rubber. Spring 2450 can be made from elastomeric rubbers including Buna N Nitrile, other nitrile rubbers, ethylene propylene, neoprene, EPDM rubber or Vitron® fluoro-elastomer, depending on the required mechanical properties and on the fuel stored in the fuel supply.

Regulator valve section 2440b includes outer housing 2460 that defines stepped internal chamber 2462. Filler 2464, spring 2466, and ball 2468 are received within internal chamber 2462.

Filler 2464 can be formed of an absorbent or retention material that can absorb and retain fuel that remains in valve 2440 when fuel cartridge 10 is disconnected from fuel cell FC. Suitable absorbent materials include, but are not limited to, hydrophilic fibers, such as those used in infant diapers and swellable gels, such as those used in sanitary napkins, or a combination thereof. Additionally, the absorbent materials can contain additive(s) that mixes with the fuel. Filler 2464 can be compressed or uncompressed when valve sections 2440a,b are connected and is uncompressed when valve sections 2440a,b are disconnected. These materials can be used for any filler discussed herein.

To open check valve section 2440a, a second check valve component contacts and moves plunger 2448 toward stop 2452 and compresses spring 2450. O-ring 2456 moves out of contact with sealing surface 2458 to open a flow path.

Valve section 2440b is sensitive to pressure. When fuel flow F occurs at a rate equal to or below a predetermined threshold pressure, fuel F moves ball 2468 out of contact with surface 2469, but not touching surface 2470 to allow fuel flow F from regulator valve section 2440b and to check valve section 2440a, as partially shown in FIG. 54. If the seal between O-ring 2456 and surface 2458 is open, fuel can flow around plunger 2448 and out check valve 2440a.

When fuel flow F occurs at a rate above this predetermined threshold pressure, the higher flow further compresses spring 2466, and moves ball 2468 into contact with surface 2470 to reduce or prevent fuel flow F, as shown in FIG. 55. When fuel flow F decreases below the predetermined threshold pressure, spring 2466 returns ball 2468 to its original position, thereby automatically resetting valve section 2440b. Spring 2466 is optional depending on whether automatic resetting feature is desired. Ball 2468 may also have a blunt leading edge similar to element 1136.

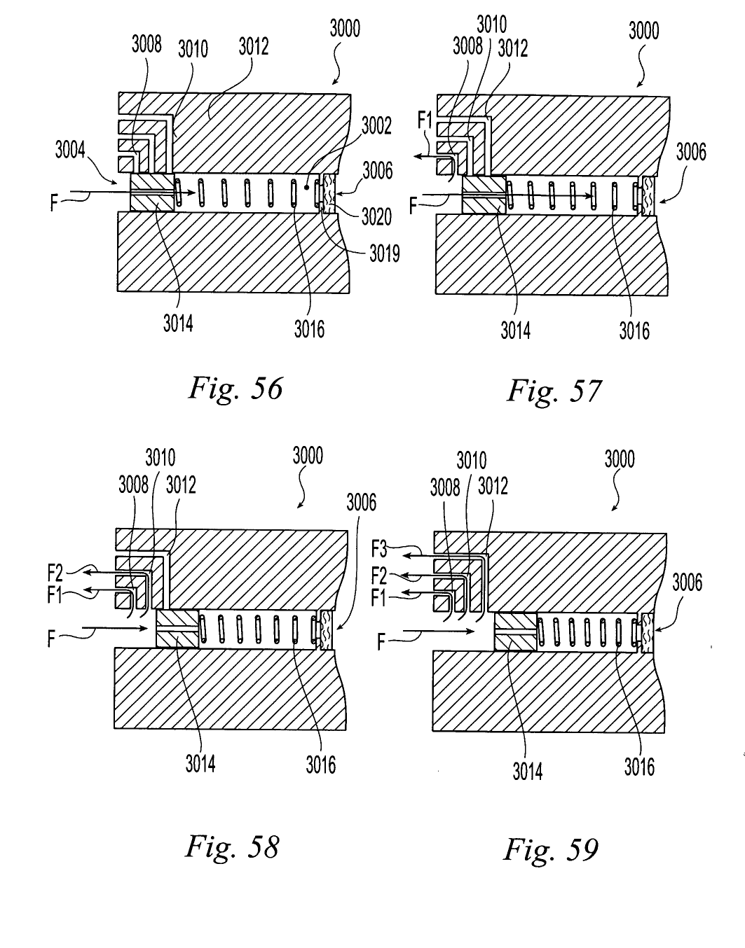

FIG. 56 illustrates a twentieth embodiment of valve 3000 that can be mated to or within cartridge 10 (in FIG. 1) or to fuel cell FC or refilling device. In this configuration, valve 3000 is coupled to or within nozzle 18b (in FIG. 1). Valve 3000 includes primary channel 3002 with inlet 3004 and outlet 3006. Inlet 3004 is connected to fuel chamber 20 and outlet 3006 is connected to fuel cell FC. Valve 3000 further includes return channels 3008, 3010, and 3012. Return channels 3008, 3010 and 3012 are connected to a separated return reservoir chamber within fuel cartridge 10.

Valve 3000 also includes a movable plunger 3014, return spring 3016, stop 3019 and filler 3020 within primary channel 3002. Plunger 3014 is formed of, for example, an elastomeric or polymeric material that is compatible with fuel F. Return spring 3016 is downstream of plunger 3014. Stop 3019 acts as a bearing surface for spring 3016 and defines an opening therein for fuel flow. Downstream of stop 3019 is optional filler 3020, which can be materials previously described for fillers.

Valve 3000 is sensitive to pressure. When fuel flow F occurs at a rate equal to or below a first predetermined threshold pressure, return spring 3016 is uncompressed and plunger 3014 remains generally stationary. As a result, plunger 3014 is in a first position (as shown in FIG. 55) upstream of return channels 3008, 3010, and 3012. Fuel F is free to flow through a channel defined within plunger 3002. Plunger 3014 is sized and dimensioned to fit snugly within primary channel 3002, so that fuel does not flow around plunger 3014. For example, plunger 3014 can have elastomeric wiper(s) between itself and the wall of channel 3002, similar to a syringe.

When fuel flow F occurs at a rate above this first predetermined threshold pressure, the higher flow compresses spring 3016 and moves plunger 3014 into second position (as shown in FIG. 57) downstream of return channel 3008 but upstream of return channels 3010 and 3012. In this position, a portion F1 of fuel flow F enters return channel 3008 and flows to reservoir within fuel cartridge 10. This helps stabilize fuel flow toward outlet 3006, and the excess flow is allowed to exit through return channel 3008.

When fuel flow F occurs at a rate above a higher second predetermined threshold pressure, the higher flow further compresses spring 3016, and moves plunger 3014 into a third position (as shown in FIG. 58) downstream of return channel 3010 but upstream of return channel 3012. In this position, portions F1 and F2 of fuel flow F enter return channels 3008, 3010 and flows to reservoir within fuel cartridge 10. This helps stabilize fuel flow toward outlet 3006 at this higher pressure, and more excess flow is allowed to exit through return channels 3008 and 3010.

When fuel flow F occurs at a rate above a higher third predetermined threshold pressure, the higher flow additionally compresses spring 3016, and moves plunger 3014 into fourth position (as shown in FIG. 59) downstream of return channel 3012. In this position, portions F1, F2, and F3 of fuel flow F enter return channels 3008, 3010, and 3012 and flows to the return reservoir within fuel cartridge 10. This helps stabilize fuel flow toward outlet 3006 at this higher pressure. Any number of return channels can be utilized.

When fuel flow F decreases below the predetermined threshold pressure, spring 3016 returns plunger 3014 to or towards its original position, thereby automatically resetting valve 3000. Spring 3016 is optional depending on whether automatic resetting feature is desired.

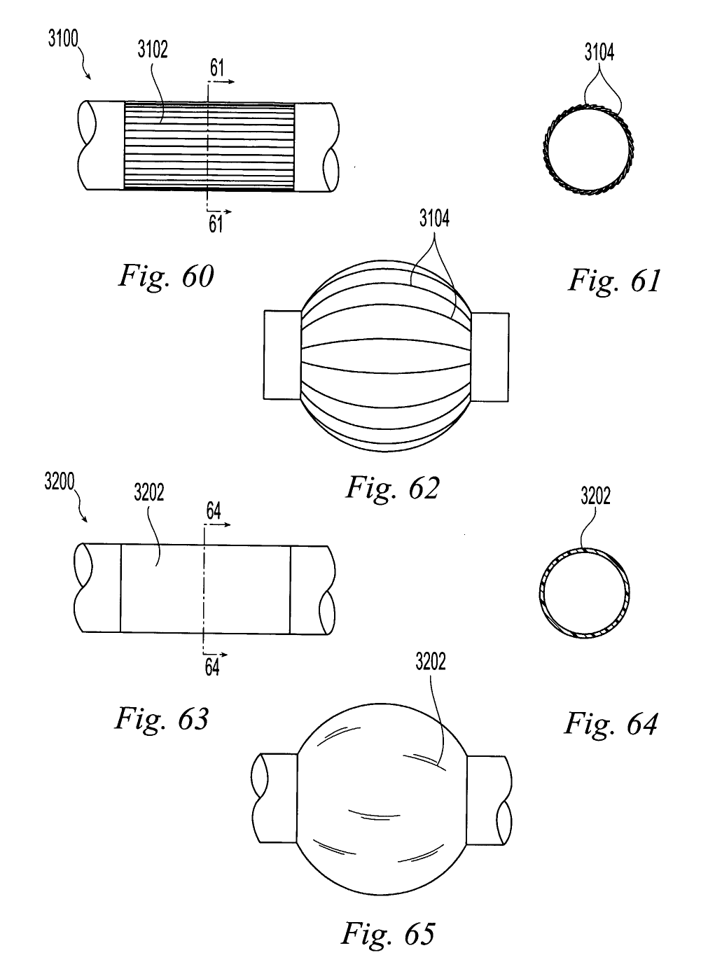

FIGS. 60-62 illustrate a twenty-first embodiment of the present invention. Valve section 3100 comprises a pressure sensitive section 3102 which has a plurality of folds 3104. Valve section 3100 connects fuel cartridge 10 to fuel cell FC. Pressure sensitive section 3102 is adapted to expand unfolding folds 3104, as shown in FIG. 62, at a predetermined pressure. At expanded section 3102, the fuel flow decreases due to the enlarged flow area, thereby preventing excess flow from reaching the fuel cell. The amount of enlarged volume available to hold excess fuel can be fixed to the anticipated fuel usage or to the volume of fuel cartridge 10. A rating system can be developed to assist in the selection of suitable valve section 3100. For example, the rating system can be based on pressure at which section 3102 expands, to protect the fuel cell and/or the volume of the fuel cartridge, e.g., the volume of the enlarged section 3102 can be at 10%-90% of the volume of the fuel cartridge.

FIGS. 63-65 illustrate a twenty-second embodiment of the present invention. Valve section 3200 is similar to valve section 3100, except that pressure sensitive section 3202 is made from an elastomeric material, such as rubber. After being expanded at or above the predetermined pressure, enlarged section 3202 may contract due to its elasticity after the pressure decreases below the predetermined pressure to push fuel back to cartridge 10 or to the fuel cell.

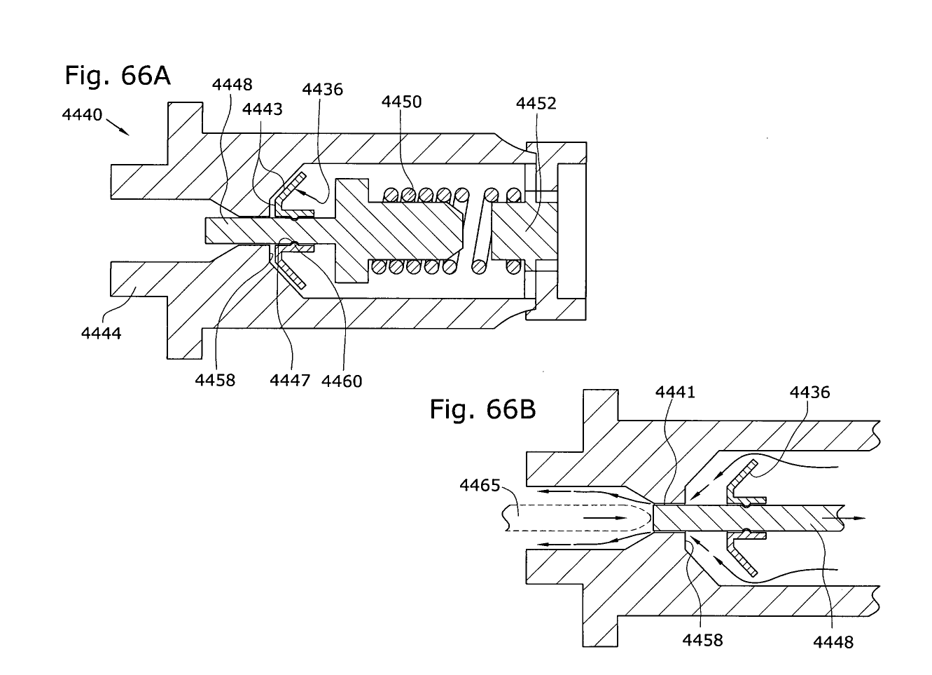

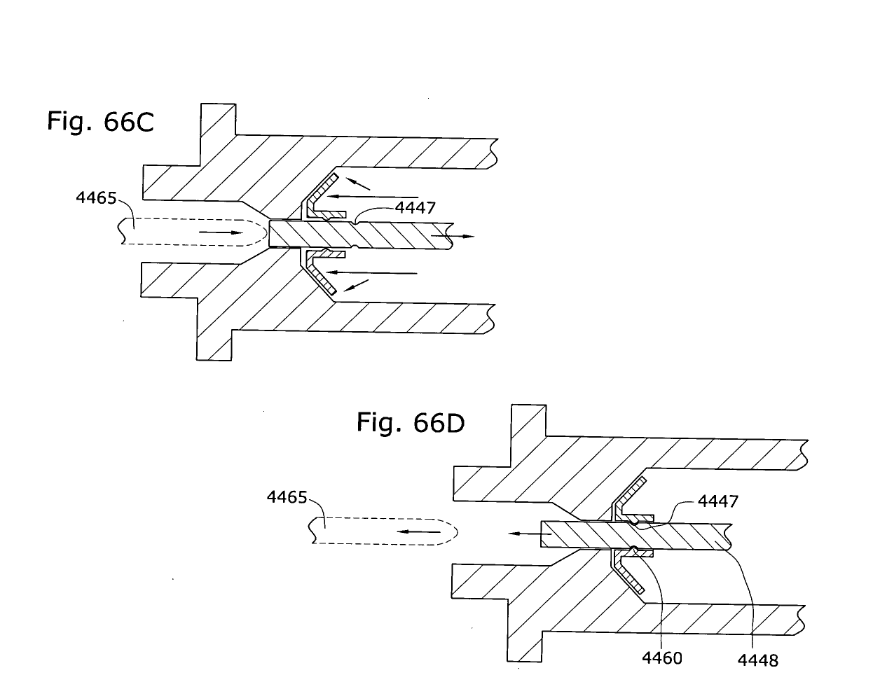

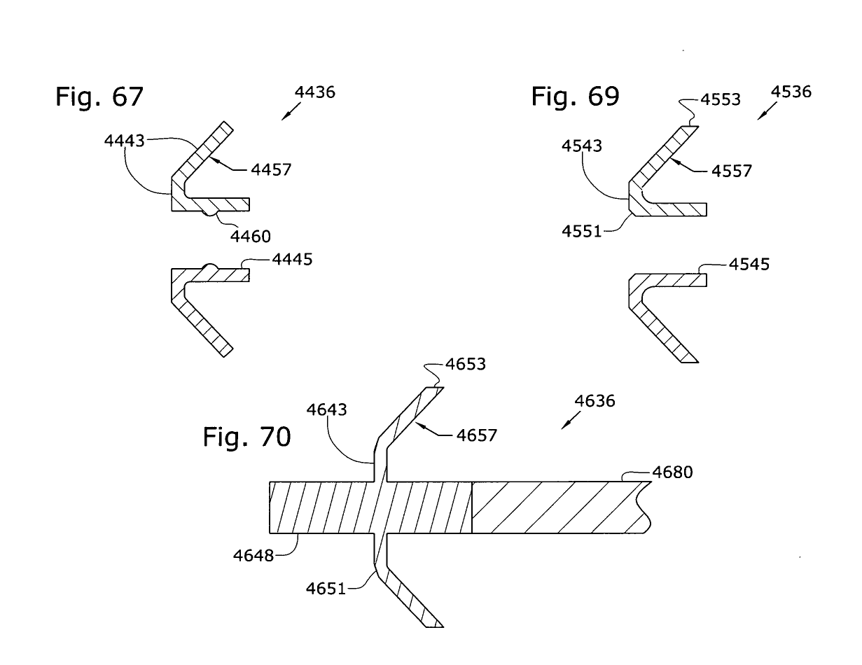

FIGS. 66A-66D and 67 illustrate a twenty-third embodiment of an environmentally sensitive valve component 4440 in various stages of operation. Valve component 4440 is a component of a two-component valve as fully disclosed in US 2005/0022883, previously incorporated by reference. Valve component 4440 includes a valve housing or body 4444, a plunger 4448 and a seal component 4436. As shown in FIG. 66A, a spring 4450 is held in compression within valve body 4444 and is supported by a spring retainer 4452. Spring 4450 biases plunger 4448 outward, thereby pressing a first sealing surface 4443 of seal component 4436 against a valve seat surface 4458 to form a seal within valve component 4440. Seal component 4436 also includes a second annular sealing surface 4445 (shown in FIG. 67) that forms a seal at its interface with plunger 4448.

In the embodiment FIGS. 66A-66D and 67, seal component 4436 includes a detent 4460 in annular sealing surface 4445 that fits within a corresponding groove 4447 in plunger 4448, wherein the detent and groove can be corresponding annular rings. As such, the valve and seal component and plunger securely interlock for retention. In another embodiment, the detent may be comprised of one or more nubs or protuberances. In another embodiment, the detent may be located on the plunger and the groove on the annular sealing surface of the seal component.

The fit between detent 4460 and groove 4447 is such that seal component 4436 is releaseably secureable to plunger 4448. As shown in FIG. 66B, when plunger 4448 is depressed by a corresponding plunger 4465 of a second valve component (not shown), seal component 4436 rides rearwardly with plunger 4448 to allow fuel to pass into and through an aperture 4441 of valve component 4440 to provide fuel to the fuel cell. However, if during operation an increase in temperature with a corresponding build-up of pressure occurs within a fuel cartridge, the excess pressure will act upon a back surface 4457 of seal component 4436 to decouple seal component 4436 from plunger 4448 and to move the seal component forwardly until first sealing surface 4443 forms a seal with valve seat surface 4458, as shown in FIG. 66C. In one embodiment of the present invention, the interlocking fit between detent 4460 and groove 4447 is sized such that it is overcome at a temperature of between 25° C. to 55° C. with an increase in pressure of greater than or equal to about 2 psi. As shown in FIG. 66D, when plunger 4465 of the second valve component is withdrawn from engagement with plunger 4448, spring 4450 will return plunger 4448 into a closed position. As plunger 4448 moves forwardly, it will thereby reset seal component 4436 by permitting detent 4460 to reenter groove 4447.

Accordingly, the seal component restricts and then stops the flow of fuel at a specific temperature and a related pressure that otherwise can cause fuel to flow at a higher rate then desired. A seal component according to the present invention is also simple in design, fuel compatible, low cost, and may be reset once the temperature/pressure of the fuel decreases. Further, the seal component is compact to be incorporated into a small space, and works in any orientation of the fuel cell.

In another embodiment, seal component 4436 is attached to plunger 4448 via an interference fit between the annular sealing surface of the seal component and the outer surface of the plunger that maintains the component on the plunger without the use of a detent and groove arrangement. The interference fit may be overcome at a certain temperature and pressure, thereby allowing the valve and seal component to move into a shut-off position. In a still further embodiment, a lip seal is positioned on the annular sealing surface of the seal component. The lip seal maintains engagement with the outer surface of the plunger when the valve and seal component is moved into an open position, and the lip seal slides along the plunger when the valve and seal component is moved into a shut-off position.

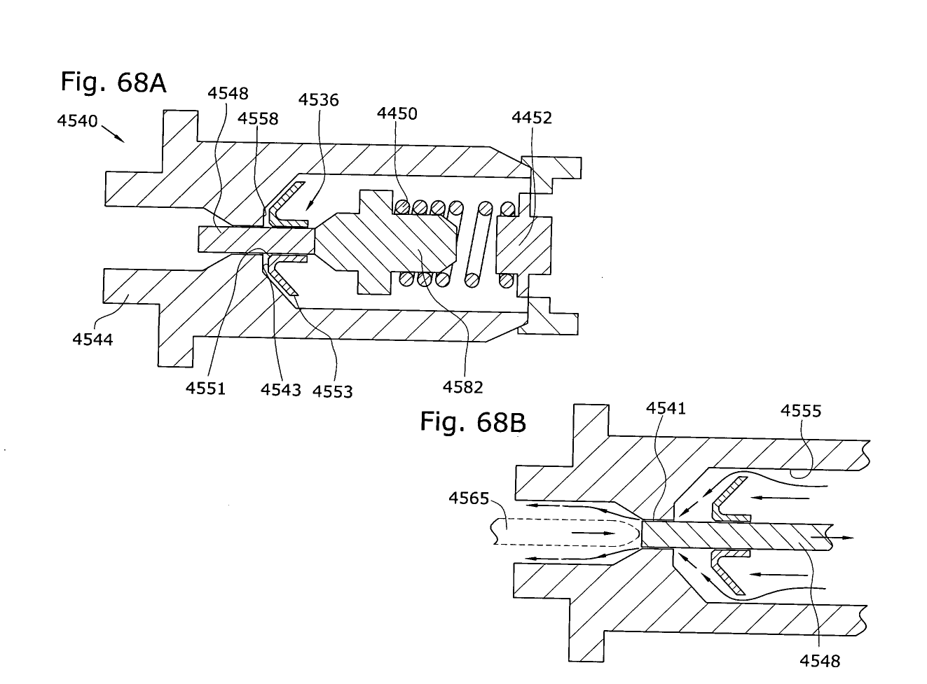

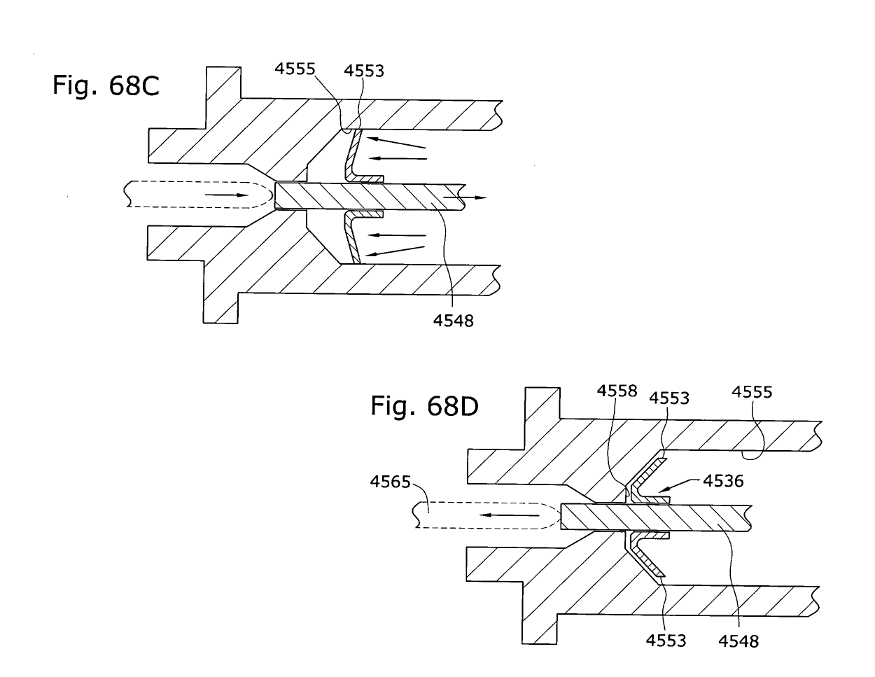

FIGS. 68A-68D and 69 illustrate a twenty-fourth embodiment of an environmentally sensitive valve component 4540 in various stages of operation. Valve component 4540 is a component of a two-component valve as fully disclosed in US 2005/0022883, previously incorporated by reference. Valve component 4540 includes a valve housing or body 4544, a plunger 4548 and a seal component 4536. As shown in FIG. 68A in a closed position, a spring 4550 is held in compression within valve body 4544 and is supported between spring retainers 4552, 4582. Spring 4550 biases plunger 4548 outward, thereby pressing a first sealing surface 4543 of seal component 4536 against a valve seat surface 4558 to form a seal within valve component 4540. Seal component 4536 also includes a second annular sealing surface 4545 (see FIG. 69) that forms a seal at its interface with plunger 4548 and a third sealing surface 4553 for sealing with a valve chamber side wall 4555 in an arrangement to be described below.

In the embodiment of FIGS. 68A-68D and 69, seal component 4536 is sealingly attached along second sealing surface 4545 to plunger 4548. As shown in FIG. 68B, when plunger 4548 is depressed by a corresponding plunger 4565 of a second valve component (not shown), seal component 4536 rides rearwardly with plunger 4548 to allow fuel to pass into and through an aperture 4541 of valve component 4540 to provide fuel to the fuel cell. However, if during operation a build-up of excess temperature and pressure occurs within a fuel cartridge, the excess pressure will act upon a back surface 4557 of seal component 4536 to bend the component at a hinge portion 4551, such that third sealing surface 4553 comes into contact with valve chamber sidewall 4555, valve seat surface 4558 or an adjacent angled surface to restrict and ultimately prevent flow. In one embodiment of the present invention, hinge portion 4551 is sized to bend at a temperature of between 25° C. and 55° C. and a pressure build-up of greater than or equal to 2 psi. As shown in FIG. 68D, when plunger 4565 of a second valve component is withdrawn from engagement with plunger 4548, spring 4550 will return plunger 4548 into a closed position. During movement into the closed position, third sealing surface 4553 can slide along valve chamber sidewall 4555, in a manner similar to a lip seal, until first sealing surface 4543 reseats into valve seat surface 4558 at which point third sealing surface 4553 will rotate back into its original position, thereby resetting seal component 4536. Hinged portion 4551 may be scored or weakened to assist in the bending motion and hinged portion 4551 may be located at other positions on seal component 4536.

In another embodiment, similar to the seal component shown in FIG. 66C, seal component 4536 may become decoupled from plunger 4548, such that the excess pressure slides third sealing surface 4553 along valve chamber sidewall 4555 until first sealing surface 4543 reseats into valve seat surface 4558 at which point third sealing surface 4553 will rotate back into its original position. Thereafter, similar to the operation of the embodiment of FIG. 66D, when plunger 4565 of the second valve component is withdrawn from engagement with plunger 4548, spring 4550 will return plunger 4548 into a closed position. As plunger 4548 moves forwardly, it will thereby reposition seal component 4536 onto the plunger by the interaction of one of the retaining mechanisms disclosed above, e.g., detent and groove, interference fit and/or lip seal.

In another embodiment as shown in FIG. 70, a seal component 4636 can be permanently fixed to or formed with a plunger portion 4648 to be a unitary component. Such a unitary component can be formed, for example, by utilizing a two-shot molding process or a weld between the sealing member and plunger portion. Alternatively, seal component 4636 and plunger portion 4648 can be formed, for example by injection molding, as a single component. Unitary seal component 4636 may be used with the valve structure of first valve component 4440, 4540, as previously described. However in this embodiment, if a build-up of excess temperature and pressure occurs within the fuel cartridge, the excess pressure will act upon a back surface 4657 of seal component 4636 and will move the unitary component until a first sealing surface 4643 reseats into a valve seat surface to restrict and then shut-off the fuel flow.

Accordingly, when a unitary component according to the embodiment of FIG. 70 is used in a two-component valve arrangement having a corresponding spring loaded plunger in the second valve component (similar to plunger 4465, 4565 shown in FIGS. 66B and 68B), an increase in pressure on seal component 4636 will increase the force of plunger 4648 acting on the corresponding plunger of the second valve component. As such, the second valve component plunger will be pushed back into the second valve component until first sealing surface 4643 of seal member 4636 moves towards and seals against the valve seat surface to thereby restrict and then stop fuel flow. In this embodiment, seal component 4636 does not need to be “hinged” or as flexible as the embodiment of FIG. 69, but its shape needs to be similar to the embodiments shown in FIGS. 67 and 69 to utilize the increase in pressure on the fuel cartridge side to move the component into a sealing position.

In another embodiment, seal component 4636 can be made of a more rigid material, such that an increased pressure on back surface 4657 further increases the force of plunger portion 4648 toward a corresponding second valve component plunger of, for example, a fuel cell. In this embodiment, a force to open the fuel cell valve (e.g., 500 g) is slightly higher than a force to open a fuel cartridge valve (e.g., 450 g) with excess force acting on a stop (e.g., 50 g) in the fuel cartridge valve. Accordingly, when the pressure increases in the fuel cartridge and acts on back surface area 4657 of seal component 4636 (e.g., to 150g) that force in combination with the fuel cartridge valve force (450g) is greater than the force to close the fuel cell valve (by 100 g), which may result in the fuel cell valve opening further (in this example, the amount the fuel cell plunger moves is necessarily equal to the distance traveled by seal component 4636 to close the fuel cartridge valve). However, the distance that the plunger of the first valve component moves can be less if seal component 4636 flexes to close the valve, as discussed with reference to the next embodiment.

In a further embodiment, seal component 4636 can be designed from a suitable material and in such a thickness that in combination with the pressure from the fuel cartridge acting on a back surface 4657 thereof a radial portion will deflect at a hinge 4651. This deflection will bring a surface 4653 of seal component 4636 into close proximity or contact with a valve chamber sidewall, a valve seat surface or an adjacent angled surface to restrict and eventually close off the valve at a predetermined pressure and/or temperature. In a still further embodiment as illustrated in FIG. 70, an optional coupling member 4680, which may include a spring retaining portion, may be utilized to implement seal component 4636 with the remaining structure of the valve component.

As disclosed above, the environmentally sensitive materials or components can have a gradual reaction to the rise in temperature, or pressure, or velocity, e.g., environmentally sensitive springs, or a steep or rapid reaction, e.g., phase change from liquid to gaseous or bimetallic springs. Both reactions are within the scope of the present invention.

Other suitable temperature sensitive materials can be used with the present invention. For example, temperature sensitive polymers, among other materials, can be used. Temperature sensitive or thermo-responsive polymers are polymers that swell or shrink in response to changes in temperature. Temperature sensitive polymers are those with either an upper critical solution temperature (UCST) or a lower critical solution temperature (LCST). These polymers have been used in biological applications. These polymers are described in U.S. Pat. No. 6,699,611 B2 and references cited therein. The '611 patent and the cited references are incorporated by reference herein in their entireties. Examples for temperature sensitive materials include, but are not limited to, interpenetrating networks (IPN) composed of poly (acrylic acid) and poly (N, N dimethylacrylamide, IPN composed of poly (acrylic acid) and poly (acryamide-co-butyl acrylate), and IPN composed of poly (vinyl alcohol) and poly (acrylic acid), among others. Also, suitable temperature sensitive materials include materials with high coefficient of thermal expansion. Exemplary materials include, but are not limited to, zinc, lead, magnesium, aluminum, tin, brass, silver, stainless steel, copper, nickel, carbon steel, irons, gold, etc., and alloys thereof.

Additionally, the bimetallic springs discussed above can be replaced by any temperature sensitive spring, including polymeric or metallic springs. Preferably, a metal or polymer is chosen so that its thermal expansion at or above the predetermined threshold temperature is sufficient to close the valve.

Also, the valve of the present invention described above can be modified so that once activated by temperature, pressure or other environmental factors, the valves shut off the flow of fuel to the fuel cell and do not re-open after the high temperature or pressure is alleviated. One method for accomplishing this is to omit the return spring or return spring force so that once activated the valves do not return to the unactivated state to allow flow.

Furthermore, at least for the pressure or velocity sensitive valves, these valves can be installed in the reversed orientation to prevent reverse flow from the fuel cell, similar to the embodiments illustrated in FIGS. 22-25.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with feature(s) and/or element(s) from other embodiment(s). Therefore, it will be understood that the appended claims are intended to cover all such modifications and embodiments which would come within the spirit and scope of the present invention.

1-72. (canceled)

73. A valve adapted for use with a fuel supply and a fuel cell, said valve comprises:
a housing; and
an environmentally sensitive member disposed within said housing, wherein the valve is movable between an actuated state and an unactuated state when a selected environmental factor changes, and wherein in the actuated state the housing and the environmentally sensitive member cooperate to alter the flow of fuel corresponding to the changed environmental factor through the valve; wherein the selected environmental factor is a pressure exerted by the fuel on the environmentally sensitive member; wherein the valve is in the unactuated state when the exerted pressure is below a predetermined pressure and in the actuated state when the exerted pressure is above the predetermined pressure; wherein in the actuated state the environmentally sensitive member cooperates with a sealing surface on the housing to seal the valve; wherein the environmentally sensitive member comprises a sealing member; and
further comprising: a plunger, wherein the plunger and the sealing member are releasably connected such that the sealing member releases from the plunger at the predetermined pressure to stop the flow of fuel to the fuel cell.

74. The valve of claim 73, wherein the sealing member includes a detent that is releasably retainable in a groove on the plunger.

75. The fuel supply of claim 74, wherein the detent and groove are annular.

76. The fuel supply of claim 73, wherein an interference fit between an interior surface of the sealing member and an outer surface of the plunger is overcome at the predetermined pressure to allow the sealing member to move relative to the plunger.

77. A valve adapted for use with a fuel supply and a fuel cell, said valve comprises:
a housing; and
an environmentally sensitive member disposed within said housing, wherein the valve is movable between an actuated state and an unactuated state when a selected environmental factor changes, and wherein in the actuated state the housing and the environmentally sensitive member cooperate to alter the flow of fuel corresponding to the changed environmental factor through the valve; wherein the selected environmental factor is a pressure exerted by the fuel on the environmentally sensitive member; wherein the valve is in the unactuated state when the exerted pressure is below a predetermined pressure and in the actuated state when the exerted pressure is above the predetermined pressure; wherein in the actuated state the environmentally sensitive member cooperates with a sealing surface on the housing to seal the valve; wherein the environmentally sensitive member comprises a sealing member; and
wherein the housing further includes a valve chamber wall and the sealing member further includes a hinge portion and a second sealing surface, wherein the hinge portion moves the second sealing surface of the sealing member into contact with the valve chamber wall at the predetermined pressure to stop the flow of fuel to the fuel cell.

78. The fuel supply of claim 77, wherein the sealing member includes an annular portion attached via the hinge portion to a wing portion including the second sealing surface, wherein the hinge portion is attached to the annular portion at an angle of greater than 90°.

79. The fuel supply of claim 78, wherein the hinge portion is thinner than one of the annular portion and the wing portion of the sealing member.

80. The fuel supply of claim 77, wherein the hinge portion of the sealing member is at an angle of greater than 90° from a longitudinal axis of the plunger.

81. The fuel supply of claim 77, wherein the hinge portion of the sealing member component is curved away from an outer surface of the plunger.

82. A valve adapted for use with a fuel supply and a fuel cell, said valve comprises:
a housing; and
an environmentally sensitive member disposed within said housing, wherein the valve is movable between an actuated state and an unactuated state when a selected environmental factor changes, and wherein in the actuated state the housing and the environmentally sensitive member cooperate to alter the flow of fuel corresponding to the changed environmental factor through the valve; wherein the selected environmental factor is a pressure exerted by the fuel on the environmentally sensitive member; wherein the valve is in the unactuated state when the exerted pressure is below a predetermined pressure and in the actuated state when the exerted pressure is above the predetermined pressure; wherein in the actuated state the environmentally sensitive member cooperates with a sealing surface on the housing to seal the valve; wherein the environmentally sensitive member comprises a sealing member; and
further comprising a plunger integrally connected to the sealing member to form a unitary component, wherein at the predetermined pressure the component moves toward the sealing surface on the housing to restrict the flow of fuel or to seal the valve.

83. The fuel supply of claim 82, wherein the sealing member and plunger component further includes a hinge portion and a second sealing surface, wherein at the predetermined pressure the hinge portion moves the second sealing surface into contact with a valve chamber wall of the housing to restrict the flow of fuel to the fuel cell.
